(19) United States
(12) Patent Application Publication
(10) Pub. No.: US 2026/0088524 A1
(43) Pub. Date: Mar. 26, 2026

(54) ELECTRICAL CONNECTOR FOR FLAT CONDUCTOR

(71) Applicant: HIROSE ELECTRIC CO., LTD., Kanagawa (JP)

(72) Inventor: Shohei YAMAGUCHI, Kanagawa (JP)

(21) Appl. No.: 19/335,888

(22) Filed: Sep. 22, 2025

(30) Foreign Application Priority Data
Sep. 24, 2024 (JP) 2024-165356

(51) Int. Cl. H01R 4/02; H01R 12/57; H01R 12/79; H01R 13/629

(52) U.S. Cl. CPC H01R 4/028; H01R 12/57; H01R 12/79; H01R 13/629

(57) ABSTRACT

Provided is an electrical connector for a flat conductor, including: a plurality of terminals; and a housing, wherein the plurality of terminals is arranged such that plate surfaces of the plurality of terminals face each other with a left-right direction of the electrical connector for the flat conductor as a terminal arrangement direction, the housing has a receiving portion, each of the plurality of terminals has a connection portion and a restriction target portion located lower than the receiving portion, the housing has a first groove portion for housing the connection portion, and a second groove portion for housing the restriction target portion, and a gap between the connection portion and a groove inner surface of the first groove portion in the terminal arrangement direction is greater than a gap between the restriction target portion and a groove inner surface of the second groove portion in the terminal arrangement direction.

### CROSS-REFERENCE TO RELATED APPLICATION

This application claims priority from Japanese Patent Application No. 2024-165356 filed with the Japan Patent Office on Sep. 24, 2024, the entire content of which is hereby incorporated by reference.

### BACKGROUND

### 1. Technical Field

The present disclosure relates to an electrical connector for a flat conductor.

### 2. Related Art

JP-A-2007-287398 discloses a connector which is mounted on a mounting surface of a circuit board and into which a flat plate-shaped cable is inserted and connected. In JP-A-2007-287398, a direction in which the flat plate-shaped cable is inserted is “rear”, but is described herein as “front”. In this connector, first terminals and second terminals formed of metal plates and alternately arranged with the width direction of the flat plate-shaped cable as a terminal arrangement direction are held by a housing made of an insulating material. Here, the first and second terminals adjacent to each other are disposed in such a posture that the plate surfaces thereof face each other. The housing is formed with first terminal holding recesses and second terminal holding recesses each corresponding to the first terminals and the second terminals, the first terminal is press-fitted from the rear and held in the first terminal holding recess, and the second terminal is press-fitted from the front and held in the second terminal holding recess. In the following description, in a case where the first terminal and the second terminal do not need to be distinguished from each other, these terminals will be collectively referred to as a “terminal(s)”, and in a case where the first terminal holding recess and the second terminal holding recess do no need to be distinguished from each other, these recesses will be collectively referred to as a “terminal holding recess(es)”.

The terminal has a tail portion coupled to an end portion of a lower arm portion extending in the front-rear direction along a lower wall of the housing, and the lower end of the tail portion is soldered to the mounting surface of the circuit board. The terminal holding recess of the housing is in the groove shape with a groove width in the terminal arrangement direction, and has a narrow portion with a small groove width and a wide portion with a greater groove width than that of the narrow portion. For example, the terminal holding recess is formed as the narrow portion in an area corresponding to a lower portion of the tail portion, and is formed as the wide portion in an area corresponding to an upper portion of the tail portion and an arm portion extending continuously to such an upper portion in the front-rear direction.

Movement of the lower portion of the tail portion in the terminal arrangement direction is restricted by the groove inner surface of the narrow portion in a state of being housed in the narrow portion. In a case where the lower portion of the tail portion is housed in the narrow portion in this manner, so-called flux wicking occurs, in which when the tail portion is soldered to the mounting surface of the circuit board, flux contained in solder is melted and rises between the plate surface of the lower portion of the tail portion and the groove inner surface of the narrow portion due to capillary action. In JP-A-2007-287398, in the terminal holding recess, the wide portion is formed in the area corresponding to the upper portion of the tail portion and the arm portion. Thus, a gap between the plate surfaces of the upper portion of the tail portion and the arm portion and the groove inner surface of the wide portion is great, and therefore, no capillary action occurs. Consequently, even when the flux wicking occurs in the narrow portion, further flux movement in the wide portion is reduced.

### SUMMARY

An electrical connector for a flat conductor according to the present disclosure is an electrical connector for a flat conductor which is mounted on a circuit board and to which a flat conductor is connected, the electrical connector for the flat conductor including: a plurality of terminals formed of metal plates; and a housing holding the plurality of terminals. In the electrical connector for the flat conductor, the plurality of terminals is arranged such that plate surfaces of the plurality of terminals face each other with a left-right direction perpendicular to a front-rear direction and an up-down direction of the electrical connector for the flat conductor as a terminal arrangement direction, the housing has a receiving portion and a plurality of housing groove portions, the receiving portion is opened rearward to receive the flat conductor inserted forward from a rear of the housing, each of the plurality of housing groove portions extends in the front-rear direction with the terminal arrangement direction as a groove width direction, and is configured to house a corresponding one of the plurality of terminals, each of the plurality of terminals has a connection portion and a restriction target portion located lower than the receiving portion, the connection portion is connectable to the circuit board, and the restriction target portion extends upward of the connection portion, each of the plurality of housing groove portions has a first groove portion for housing the connection portion, and a second groove portion for housing the restriction target portion, and a gap between the connection portion and a groove inner surface of the first groove portion in the terminal arrangement direction is greater than a gap between the restriction target portion and a groove inner surface of the second groove portion in the terminal arrangement direction.

### BRIEF DESCRIPTION OF THE DRAWINGS

FIG. 1 is a perspective view showing, together with a flat conductor, an electrical connector for a flat conductor according to an embodiment of the present disclosure, and shows a state immediately before insertion of the flat conductor;

FIG. 2 is a perspective view showing the electrical connector for the flat conductor with members thereof disassembled;

FIG. 3A is a sectional view of a housing at the position of a first terminal housing groove portion, and FIG. 3B is a sectional view of the electrical connector for the flat conductor at the position of the first terminal housing groove portion;

FIG. 4A is a sectional view of the housing at the position of a second terminal housing groove portion, and FIG. 4B is a sectional view of the electrical connector for the flat conductor at the position of the second terminal housing groove portion;

FIG. 5A is a sectional view of the housing at the position of a lock metal fitting housing groove portion, and FIG. 5B is a sectional view of the electrical connector for the flat conductor at the position of the lock metal fitting housing groove portion;

FIG. 6A is a plan view of part of the electrical connector for the flat conductor, and FIG. 6B is a bottom view of part of the electrical connector for the flat conductor;

FIGS. 7A and 7B are views showing a section at the position of a first contact portion of a first terminal in a front-rear direction, FIG. 7A shows a state as viewed diagonally from the rear, and FIG. 7B shows a state as viewed from the rear;

FIGS. 8A to 8C are sectional views of the electrical connector for the flat conductor immediately before insertion of the flat conductor, FIG. 8A shows a section at the position of the first terminal, FIG. 8B shows a section at the position of a second terminal, and FIG. 8C shows a section at the position of a lock metal fitting;

FIGS. 9A to 9C are sectional views of the electrical connector for the flat conductor immediately after the insertion of the flat conductor, FIG. 9A shows the section at the position of the first terminal, FIG. 9B shows the section at the position of the second terminal, and FIG. 9C shows the section at the position of the lock metal fitting;

FIGS. 10A to 10C are sectional views of the electrical connector for the flat conductor immediately after completion of connection of the flat conductor, FIG. 10A shows the section at the position of the first terminal, FIG. 10B shows the section at the position of the second terminal, and FIG. 10C shows the section at the position of the lock metal fitting; and

FIG. 11 is a perspective view showing part of an electrical connector for a flat conductor according to a modification.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In the connector of JP-A-2007-287398, in order to stabilize the position of the tail portion in the terminal arrangement direction, the narrow portion is provided in the area corresponding to the lower portion of the tail portion in the terminal holding recess. Thus, in the connector of JP-A-2007-287398, it is assumed that the flux wicking occurs in such an area, and there is still room for improvement on the point that the flux wicking is reduced.

The present disclosure has been made in view of such a situation, and one object thereof is to provide an electrical connector for a flat conductor capable of favorably maintaining a terminal at a normal position in a terminal arrangement direction and favorably reducing solder wicking and flux wicking (hereinafter merely referred to as “solder wicking” in a case where these types of wicking do not need to be distinguished from each other).

(1) An electrical connector for a flat conductor according to the present disclosure is an electrical connector for a flat conductor which is mounted on a circuit board and to which a flat conductor is connected. The electrical connector for the flat conductor includes: a plurality of terminals formed of metal plates; and a housing holding the plurality of terminals. The plurality of terminals is arranged such that plate surfaces of the plurality of terminals face each other with a left-right direction perpendicular to a front-rear direction and an up-down direction of the electrical connector for the flat conductor as a terminal arrangement direction, the housing has a receiving portion and a plurality of housing groove portions, the receiving portion is opened rearward to receive the flat conductor inserted forward from a rear of the housing, each of the plurality of housing groove portions extends in the front-rear direction with the terminal arrangement direction as a groove width direction, and is configured to house a corresponding one of the plurality of terminals, each of the plurality of terminals has a connection portion and a restriction target portion located lower than the receiving portion, the connection portion is connectable to the circuit board, and the restriction target portion extends upward of the connection portion, each of the plurality of housing groove portions has a first groove portion for housing the connection portion, and a second groove portion for housing the restriction target portion, and a gap between the connection portion and a groove inner surface of the first groove portion in the terminal arrangement direction is greater than a gap between the restriction target portion and a groove inner surface of the second groove portion in the terminal arrangement direction.

In the present disclosure, in the housing groove portion of the housing, the gap between the connection portion and the groove inner surface of the first groove portion is greater than the gap between the restriction target portion and the groove inner surface of the second groove portion. That is, the great gap is formed in the groove width direction between the plate surface of the connection portion which is the portion directly soldered to the mounting surface of the circuit board and the groove inner surface of the first groove portion. Thus, when the connection portion is soldered to the circuit board, no capillary action occurs in the gap between the connection portion and the groove inner surface of the first groove portion, and the solder wicking can be favorably reduced.

Moreover, in the present disclosure, in the housing groove portion of the housing, the gap between the restriction target portion and the groove inner surface of the second groove portion is smaller than the gap between the connection portion and the groove inner surface of the first groove portion. Thus, movement of the restriction target portion in the terminal arrangement direction (left-right direction) is restricted by the groove inner surface of the second groove portion. Consequently, the restriction target portion and the connection portion are easily maintained at normal positions in the terminal arrangement direction. Further, the second groove portion is formed higher, which is on the opposite side of the circuit board side, than the first groove portion in the thickness direction (up-down direction) of the flat conductor. Thus, as long as no solder wicking occurs in the first groove portion located on the lower side, which is the circuit board side, as described above, no solder wicking occurs in the second groove portion.

(2) In the disclosure of (1), each of the plurality of terminals further may have a holding target portion to be held by the housing, and a contact arm portion and a base arm portion located lower than the receiving portion and extending rearward of the holding target portion, the contact arm portion may have a contact portion contactable with the flat conductor, the base arm portion may be located lower than the contact arm portion, and may have an area overlapping with the contact arm portion in the front-rear direction, the connection portion may be provided at a rear end of the base arm portion, each housing groove portion may have a third groove portion communicating with the first groove portion and provided for housing the base arm portion, and a gap between the base arm portion and a groove inner surface of the third groove portion in the terminal arrangement direction may be greater than the gap between the restriction target portion and the groove inner surface of the second groove portion in the terminal arrangement direction.

In the present disclosure, the contact arm portion and the base arm portion are provided with the areas overlapping with each other in the front-rear direction, and therefore, the terminal can be reduced in size in the front-rear direction by an amount corresponding to such an overlap. With this shape, the connection portion coupled to the rear end of the base arm portion is located close to the contact portion. However, since the base arm portion and the contact arm portion are formed as separate arm portions, in the terminal, a continuous path from the connection portion to the contact portion is a path along the base arm portion, the holding target portion, and the contact arm portion. Thus, the connection portion and the contact portion are greatly apart from each other on this path. Further, the gap between the base arm portion and the groove inner surface of the third groove portion is greater than the gap between the restriction target portion and the groove inner surface of the second groove portion. That is, the great gap is formed between the plate surface of the base arm portion and the groove inner surface of the third groove portion, and therefore, no solder wicking occurs in the area of the base arm portion. Thus, movement of molten solder from the connection portion to the contact portion can be more favorably reduced.

(3) In the disclosure of (2), each of the plurality of housing groove portions may have a fourth groove portion for housing part of the contact arm portion, and a gap between the part of the contact arm portion and a groove inner surface of the fourth groove portion in the terminal arrangement direction may be smaller than the gap between the base arm portion and the groove inner surface of the third groove portion in the terminal arrangement direction. With this configuration, movement of the contact arm portion in the terminal arrangement direction can be restricted by the groove inner surface of the fourth groove portion. Thus, the contact portion is easily maintained at a normal position in the terminal arrangement direction.

(4) In the disclosure of (3), a groove width of the second groove portion and a groove width of the fourth groove portion may be equal to each other, and the second groove portion and the fourth groove portion may communicate with each other to form one groove portion. Since the second groove portion and the fourth groove portion communicate with each other to form one groove portion as described above, the housing groove portion can be formed in a simple shape, and therefore, the housing is easily manufactured.

(5) In the disclosure of (3) or (4), the contact portion may protrude upward to the receiving portion such that a protruding end of the contact portion is located in the receiving portion, each of the plurality of housing groove portions have a fifth groove portion for housing part of the contact portion, and the fifth groove portion may have a front inner surface located in an area of the contact portion in the front-rear direction and extend to the front inner surface from a rear end of the housing in the front-rear direction, and a gap between the part of contact portion and a groove inner surface of the fifth groove portion in the terminal arrangement direction may be greater than the gap between the part of the contact arm portion and the groove inner surface of the fourth groove portion in the terminal arrangement direction.

Considering the easiness of the insertion of the flat conductor and the state of contact between the contact portion and the flat conductor, in a case where the contact portion protrudes into the receiving portion, it is important to accurately identify the position of the protruding end of the contact portion in the up-down direction. Thus, for the manufactured connector, an inspection for identifying the position of the protruding end of the contact portion may be performed. In this case, for example, the inspection is performed in such a manner that light is emitted to the receiving portion from the rear of the connector and a light reflection state is imaged from the rear. In this inspection, the position of the protruding end of the contact portion is identified based on a difference in light and dark (contrast) between light reflected on the contact portion protruding into the receiving portion and light reflected on a portion around the contact portion when viewed from the rear in the captured image.

If the dimension of the gap between the part of the contact portion and the groove inner surface of the fifth groove portion is equal to or less than the dimension of the gap between the part of the contact arm portion and the groove inner surface of the fourth groove portion, the position of the protruding end of the contact portion is identified based on the contrast between light reflected on the contact portion and light reflected on the rear end surface of a portion of the housing formed with the fifth groove portion. However, in a case where the dimension of the gap between the part of the contact portion and the groove inner surface of the fifth groove portion is greater than the dimension of the gap between the part of the contact arm portion and the groove inner surface of the fourth groove portion, the rear end surface of the portion of the housing formed with the fifth groove portion is shifted rearward from the contact portion. For this reason, it is difficult to bring both the rear end surface and the contact portion into focus at the time of imaging and to capture a clear image.

In the present disclosure, the part of the contact portion is housed in the fifth groove portion, and the gap between the part of the contact portion and the groove inner surface of the fifth groove portion is greater than the gap between the part of the contact arm portion and the groove inner surface of the fourth groove portion. Moreover, the fifth groove portion is closed from the front with the front inner surface. In other words, the fifth groove portion has the front inner surface located in the area of the contact portion in the front-rear direction, and extends from the rear end of the housing to the front inner surface in the front-rear direction. Thus, when viewed from the rear, the front inner surface is present around the contact portion. Consequently, the position of the protruding end of the contact portion can be identified based on the contrast between light reflected on the contact portion and light reflected on the front inner surface. In the present disclosure, the front inner surface is located in the area of the contact portion in the front-rear direction, and is near the contact portion in the front-rear direction. Thus, it is easy to bring both the front inner surface and the contact portion into focus at the time of imaging and to capture a clear image, and therefore, the position of the protruding end of the contact portion can be easily identified.

(6) In the disclosure of (1), a groove width of the first groove portion may be greater than a groove width of the second groove portion.

(7) In the disclosure of (2), a groove width of the third groove portion may be greater than a groove width of the second groove portion.

(8) In the disclosure of (3), a groove width of the fourth groove portion may be greater than a groove width of the third groove portion.

(9) In the disclosure of (5), a groove width of the fifth groove portion may be greater than a groove width of the fourth groove portion.

In the present disclosure, the electrical connector for the flat conductor can be provided, which is capable of favorably maintaining the terminal at the normal position in the terminal arrangement direction and favorably reducing the solder wicking.

Hereinafter, an embodiment of the present disclosure will be described based on the attached drawings.

An electrical connector 1 for a flat conductor (hereinafter referred to as a “connector 1”) according to the present embodiment is mounted on a mounting surface of a circuit board (not shown), and is configured such that a flat conductor C (for example, FPC) which is a partner connection body is insertable into and extractable from the connector 1 with a front-rear direction (X-axis direction) parallel with the mounting surface as an insertion-extraction direction. The flat conductor C is connected to the connector 1, and in this manner, the circuit board and the flat conductor C are brought into electrical conduction with each other.

In the present embodiment, the X-axis direction is the front-rear direction, an X1 direction is a forward direction, and an X2 direction is a rearward direction. Moreover, a Y-axis direction perpendicular to the front-rear direction in a plane (XY plane) parallel with the mounting surface of the circuit board is a left-right direction, a Y1 direction is a leftward direction, and a Y2 direction is a rightward direction. In the following description, the left-right direction may be referred to as a terminal arrangement direction or a groove width direction. Further, a Z-axis direction perpendicular to the mounting surface of the circuit board is an up-down direction, a Z1 direction is an upward direction, and a Z2 direction is a downward direction. The front-rear direction, the left-right direction, and the up-down direction are the length direction, width direction, and thickness direction of the connector 1, respectively. In the present embodiment, the left-right direction perpendicular to the front-rear direction and the up-down direction is the terminal arrangement direction.

The flat conductor C is in a band shape extending in the front-rear direction (X-axis direction) and the left-right direction (Y-axis direction) and formed flexible with the up-down direction (Z-axis direction) as a thickness direction. The flat conductor C is inserted into and extracted from the connector 1 with the front-rear direction (X-axis direction) as the insertion-extraction direction. Note that the front-rear direction can also be referred to as the length direction of the flat conductor C and the left-right direction can also be referred to as the width direction of the flat conductor C.

The flat conductor C is formed such that a plurality of circuit portions extending in the front-rear direction is arranged in the width direction (Y-axis direction) of the flat conductor C. Such a circuit portion is embedded in an insulating layer of the flat conductor C, extends in the front-rear direction (X-axis direction), and reaches the front end position of the flat conductor C. Moreover, these circuit portions have, at front end portions (X1-side portions) thereof, connection circuit portions C1 exposed on the upper surface side of the flat conductor C, and are contactable with first terminals 20 and second terminals 30 of the connector 1 described later. The connection circuit portions C1 have first circuit portions C1A contactable with the first terminals 20 and second circuit portions C1B contactable with the second terminals 30. The first circuit portions C1A and the second circuit portions C1B are alternately located in the width direction of the flat conductor C, and are located with shifted from each other in the front-rear direction.

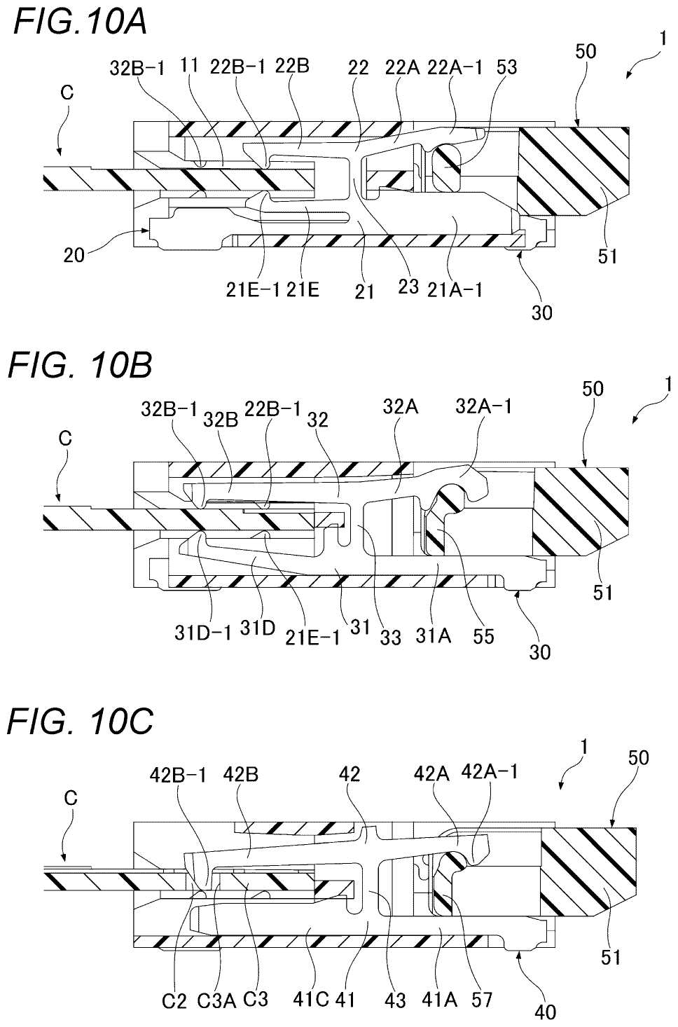

The flat conductor C is formed with cutouts C2 at both side edge portions of a front end portion thereof. An ear portion C3 is formed in front of the cutout C2 of the flat conductor C. A rear end edge portion of the ear portion C3 functions as a locking target portion C3A to be locked to a locking portion 42B-1 of the connector 1 (see FIG. 10C).

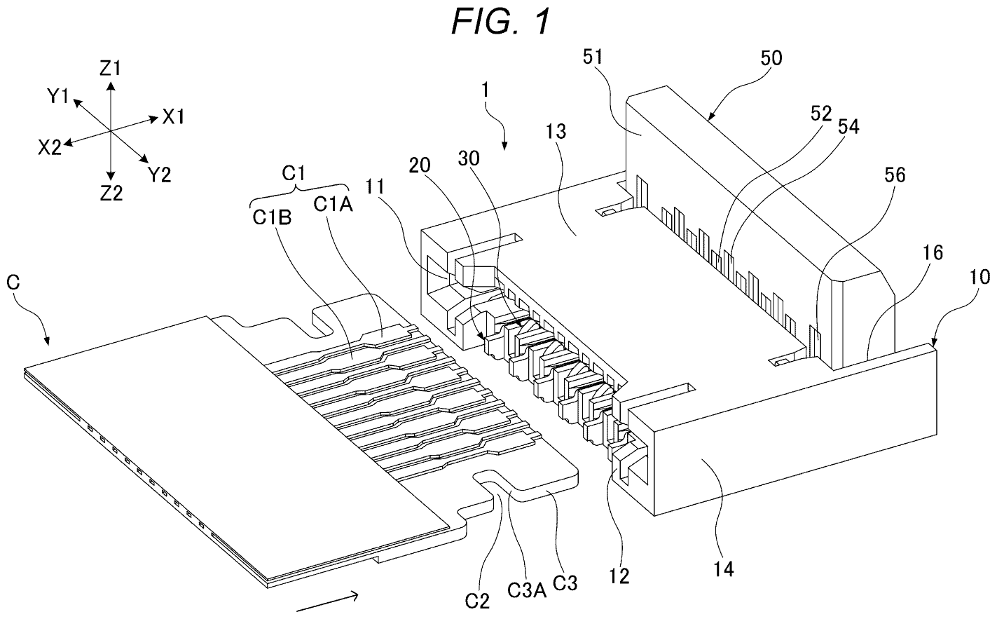

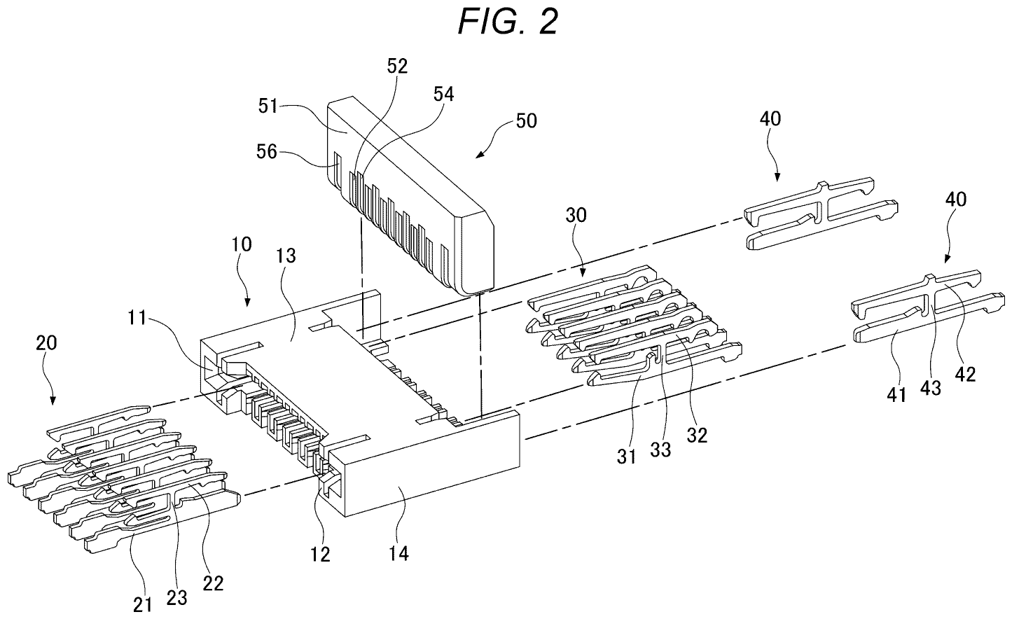

As shown in FIGS. 1 and 2, the connector 1 includes a housing 10 made of an electrical insulating material such as resin, the plurality of first terminals 20 and the plurality of second terminals 30 formed of metal plates, a lock metal fitting 40 formed of a metal plate, and a movable member 50 made of an electrical insulating material such as resin. The first terminals 20 and the second terminals 30 are arranged with the left-right direction (Y-axis direction) as the terminal arrangement direction, and are held by the housing 10. The lock metal fitting 40 includes lock metal fittings 40 disposed on both outer sides of a terminal arrangement area in the terminal arrangement direction. The movable member 50 is movable between a closed position and an open position. The connector 1 is configured such that the flat conductor C is inserted and connected forward into the connector 1 from the rear thereof.

As shown in FIGS. 1 and 2, the first terminals 20 and the second terminals 30 are alternately arranged in the terminal arrangement direction (Y-axis direction), and are disposed such that the plate surfaces of the first terminals 20 and the second terminals 30 face each other in the terminal arrangement direction. One lock metal fitting 40 is provided on each outer side of the terminal arrangement area, and is provided such that the plate surface of the lock metal fitting 40 faces the plate surfaces of the first terminals 20 and the second terminals 30 in the terminal arrangement direction.

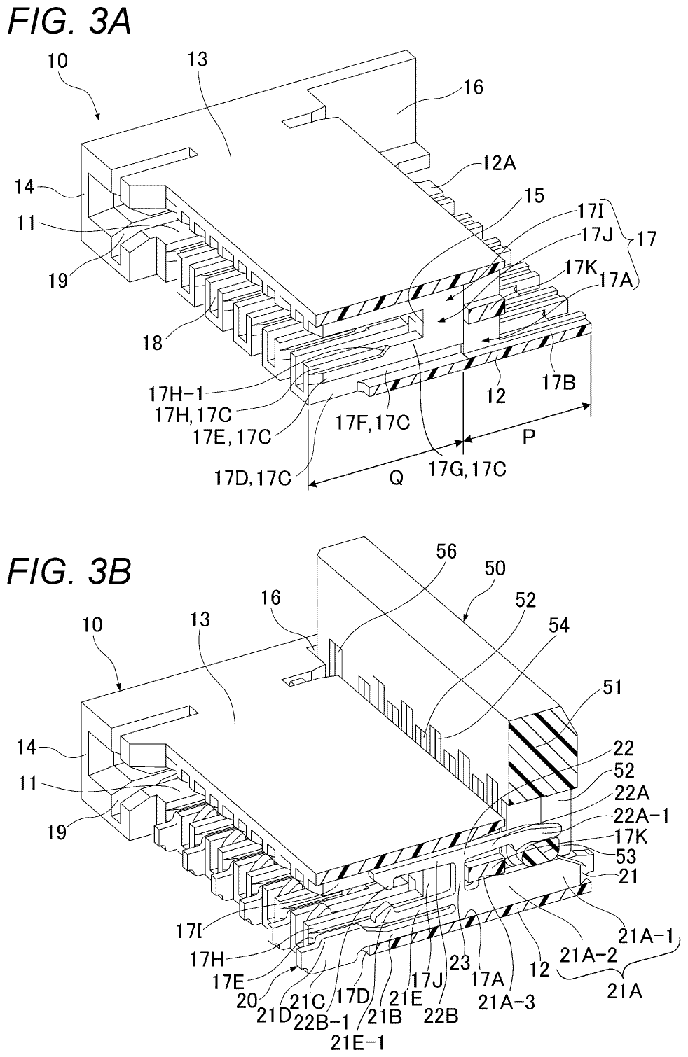

As shown in FIG. 1, the housing 10 has a substantially rectangular parallelepiped outer shape with the terminal arrangement direction as a longitudinal direction, and a receiving portion 11 for receiving the flat conductor C is formed as a space opened rearward. The housing 10 has a lower wall 12 facing the mounting surface of the circuit board, an upper wall 13 extending in parallel with the lower wall 12 above the lower wall 12, two side walls 14 extending in the up-down direction and coupling both end portions of the lower wall 12 and the upper wall 13 in the terminal arrangement direction, and a front wall 15 (see FIG. 3A) coupling the front ends of the lower wall 12 and the upper wall 13. A movable member housing space 16 for housing the movable member 50 is formed between the two side walls 14 in the terminal arrangement direction in front of the front wall 15.

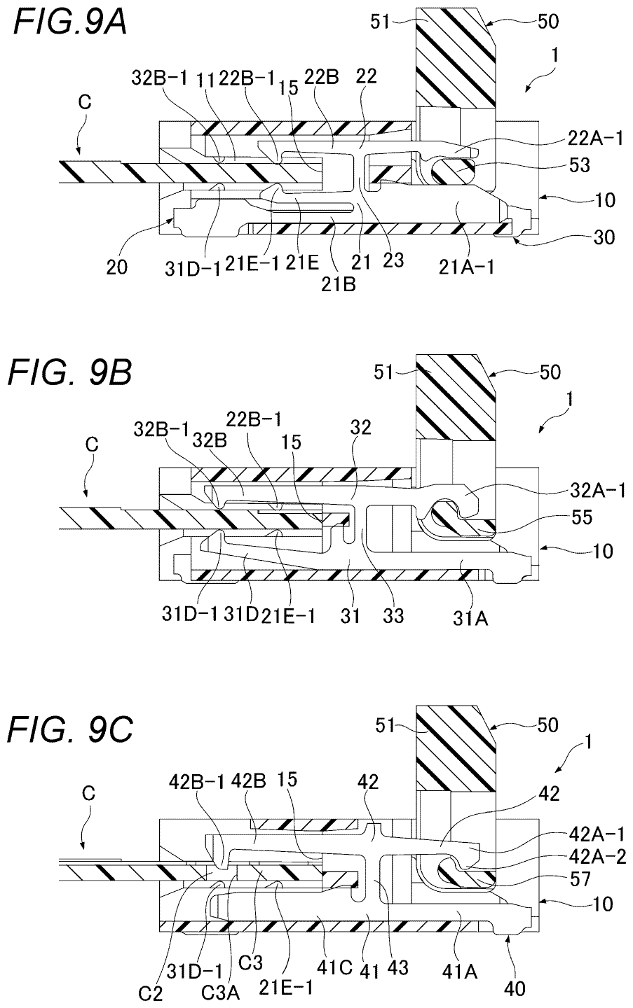

The receiving portion 11 is surrounded by the lower wall 12, the upper wall 13, and the two side walls 14, and is configured to receive the front end portion of the flat conductor C from the rear (see FIGS. 9A to 9C).

As shown in FIGS. 1 and 3A, the rear ends of portions of the lower wall 12 and the upper wall 13 in the terminal arrangement area are located forward of the rear ends of portions of the lower wall 12 and the upper wall 13 outside the terminal arrangement area. Moreover, as shown in FIG. 3A, the front ends of the portions of the lower wall 12 and the upper wall 13 in the terminal arrangement area are located rearward of the front ends of the portions of the lower wall 12 and the upper wall 13 outside the terminal arrangement area.

As shown in FIGS. 3A, 4A, and 5A, the lower wall 12 has a projection 12A projecting forward of the front wall 15. The upper surface of the projection 12A is located lower than the upper surface of other portions (portion other than the projection 12A) of the lower wall 12, and the lower surface of the projection 12A is at the same position as that of the lower surfaces of the other portions in the up-down direction. That is, the projection 12A is thinner than the other portions of the lower wall 12, that is, is formed with a small wall thickness.

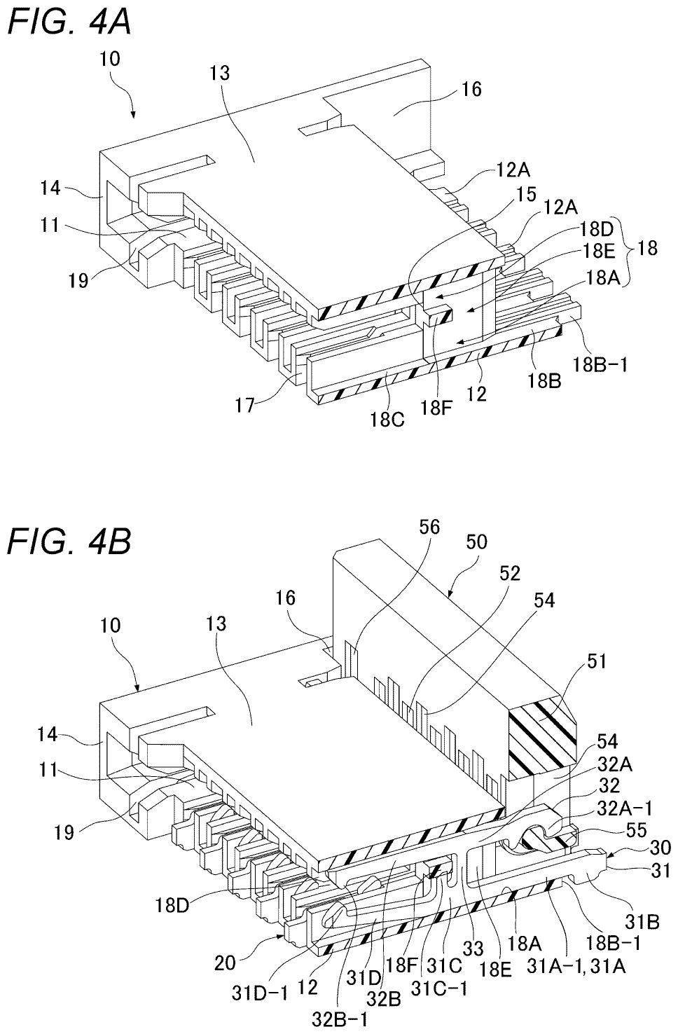

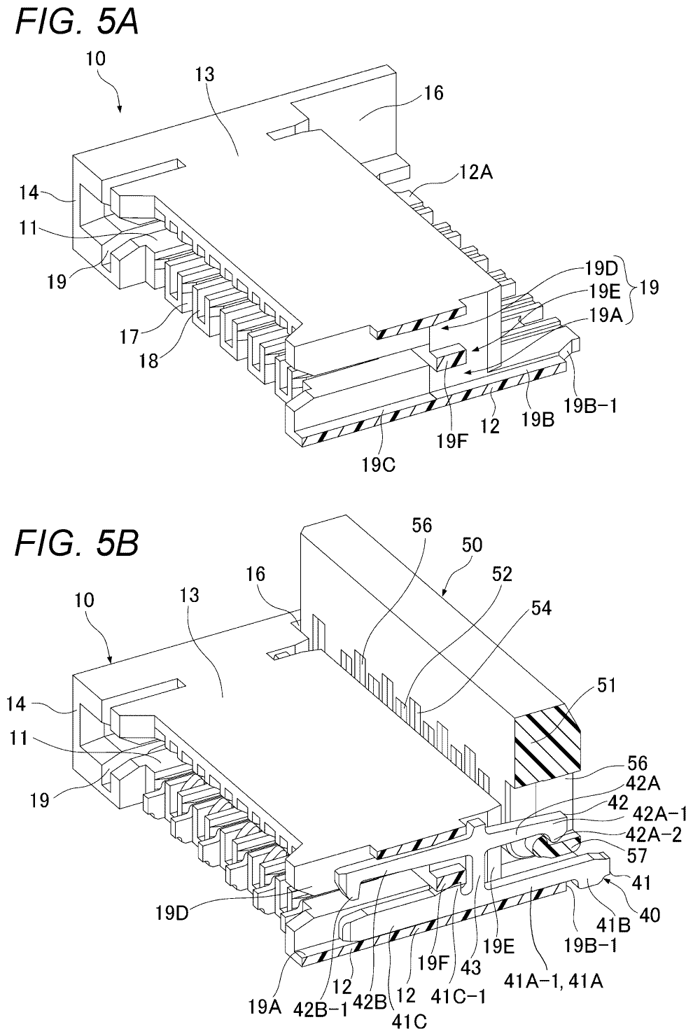

As shown in FIGS. 3A and 4A, in the terminal arrangement area in the terminal arrangement direction, the housing 10 is formed with first terminal housing groove portions 17 for housing and holding the first terminals 20 and second terminal housing groove portions 18 for housing and holding the second terminals 30. The first terminal housing groove portions 17 and the second terminal housing groove portions 18 are alternately arranged at predetermined intervals in the terminal arrangement direction. Moreover, as shown in FIG. 5A, the housing 10 is formed, on both end sides of the receiving portion 11 in the terminal arrangement direction, in other words, both outer sides of the terminal arrangement area, with lock metal fitting housing groove portions 19 for housing and holding the lock metal fittings 40.

As shown in FIG. 3A, the first terminal housing groove portion 17 is formed in a slit shape extending in the front-rear direction with the terminal arrangement direction as a groove width direction. The first terminal housing groove portion 17 is formed so as to penetrate the housing 10 in the front-rear direction. The first terminal housing groove portion 17 has a plurality of portions different from each other in a groove width dimension (dimension in the terminal arrangement direction). Specifically, the first terminal housing groove portion 17 has a narrow portion with a groove width dimension slightly wider than the plate thickness dimension (dimension in the terminal arrangement direction) of the first terminal 20, and a wide portion with a greater groove width dimension than that of the narrow portion.

The first terminal housing groove portion 17 has a lower groove portion 17A extending in the front-rear direction along the lower wall 12, an upper groove portion 17I extending in the front-rear direction along the upper wall 13, and a front groove portion 17J extending in the up-down direction along the front wall 15.

The lower groove portion 17A is recessed from the upper surface of the lower wall 12, extends in the front-rear direction, and penetrates the lower wall 12. As shown in FIG. 3A, the lower groove portion 17A has, with an intermediate position in the front-rear direction, specifically the rear end position of a first terminal holding portion 17K described later, as a boundary, a front lower groove portion 17B located in an area P in front of the intermediate position, and a rear lower groove portion 17C located in an area Q in rear of the intermediate position.

The front lower groove portion 17B is formed narrow over the entire area. A rear portion of the front lower groove portion 17B is formed in a partial area of the front wall 15 in the front-rear direction, specifically the area of the first terminal holding portion 17K, and a front portion of the front lower groove portion 17B is formed in the area of the projection 12A in front of the front wall 15.

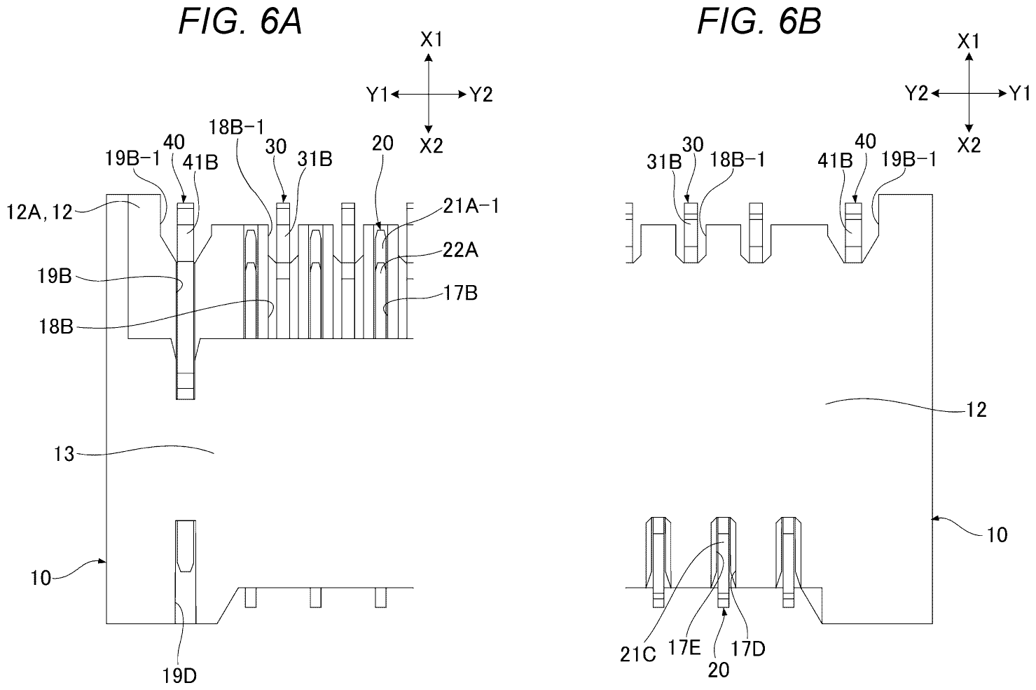

As shown in FIG. 3A, the rear lower groove portion 17C has a first groove portion 17D, a second groove portion 17E, a third groove portion 17F, a fourth groove portion 17G, and a fifth groove portion 17H. The first groove portion 17D, the third groove portion 17F, and the fifth groove portion 17H are formed wide, and the second groove portion 17E and the fourth groove portion 17G are formed narrow. The first groove portion 17D is formed, in a lower portion of a rear portion of the rear lower groove portion 17C, so as to penetrate the lower wall 12 in the up-down direction. The second groove portion 17E is formed at an intermediate position in the up-down direction in a rear portion of the rear lower groove portion 17C. The second groove portion 17E is located immediately above the first groove portion 17D, in other words, on the opposite side of the circuit board in the up-down direction, and extends in the front-rear direction along the first groove portion 17D. As shown in FIGS. 3A and 6B, a rear end portion of the second groove portion 17E increases in a groove width as extending rearward.

As shown in FIG. 3A, the third groove portion 17F extends, in front of the first groove portion 17D, to the front end position of the rear lower groove portion 17C, in other words, the rear end position of the front lower groove portion 17B. The third groove portion 17F is formed with the same groove width dimension as that of the first groove portion 17D, and together with the first groove portion 17D, forms one wide groove portion. The first groove portion 17D and the third groove portion 17F communicate with each other and form one groove portion as described above, so that the first terminal housing groove portion 17 can be formed in a simple shape and therefore the housing 10 can be easily manufactured.

As shown in FIG. 3A, the fourth groove portion 17G is located immediately above the third groove portion 17F in front of the second groove portion 17E and the fifth groove portion 17H, and extends to the front end position of the rear lower groove portion 17C along the third groove portion 17F. The fourth groove portion 17G is formed with the same groove width dimension as those of the front lower groove portion 17B and the second groove portion 17E, and together with the front lower groove portion 17B and the second groove portion 17E, forms one narrow groove portion in the lower groove portion 17A. The front lower groove portion 17B, the second groove portion 17E, and the fourth groove portion 17G communicate with each other and form one groove portion as described above, so that the first terminal housing groove portion 17 can be formed in a simple shape and therefore the housing 10 can be easily manufactured.

As shown in FIG. 3A, the fifth groove portion 17H is formed in an upper portion of a rear portion of the rear lower groove portion 17C. The fifth groove portion 17H is located immediately above the second groove portion 17E, and extends from the intermediate position of the rear lower groove portion 17C to the rear end position of the lower wall 12 in the front-rear direction along the second groove portion 17E. The fifth groove portion 17H is formed with the same groove width dimension as those of the first groove portion 17D and the third groove portion 17F, and forms a wide groove portion.

As shown in FIG. 3A, the fifth groove portion 17H is closed from the front with a front inner surface 17H-1 at positions on both end sides in the groove width direction. In other words, the fifth groove portion 17H extends to the front inner surface 17H-1 from the rear end of the housing 10 (the rear end of the lower wall 12) in the front-rear direction. The front inner surface 17H-1 is located in the area of a first lower contact portion 21E-1 (see FIG. 3B) of the first terminal 20 in the front-rear direction, and forms an inclined surface inclined upward as extending forward. As described later, the front inner surface 17H-1 is utilized as a reflection surface for reflecting light emitted from the rear when an inspection for identifying the position of the protruding end of the first lower contact portion 21E-1 is performed.

The upper groove portion 17I is recessed from the lower surface of the upper wall 13, extends in the front-rear direction, and penetrates the upper wall 13. The front groove portion 17J extends in the up-down direction, causes the lower groove portion 17A and the upper groove portion 17I to communicate with each other, and penetrates the front wall 15 in the front-rear direction. The upper groove portion 17I and the front groove portion 17J are formed narrow with the same groove width dimension as those of the front lower groove portion 17B, the second groove portion 17E, and the fourth groove portion 17G of the lower groove portion 17A. Moreover, as shown in FIG. 3A, a front portion of the front groove portion 17J is formed with the first terminal holding portion 17K in which the first terminal 20 is to be press-fitted and held. The first terminal holding portion 17K extends in the groove width direction, and couples the opposing groove inner surfaces (two surfaces facing each other in the groove width direction) of the front groove portion 17J.

As shown in FIG. 4A, the second terminal housing groove portion 18 is formed in a slit shape extending in the front-rear direction with the terminal arrangement direction as a groove width direction. The second terminal housing groove portion 18 is formed so as to penetrate the housing 10 in the front-rear direction. The second terminal housing groove portion 18 has a plurality of portions different from each other in a groove width dimension. Specifically, the second terminal housing groove portion 18 has a narrow portion with a groove width dimension slightly wider than the plate thickness dimension of the second terminal 30, and a wide portion with a greater groove width dimension than that of the narrow portion.

The second terminal housing groove portion 18 has a lower groove portion 18A extending in the front-rear direction along the lower wall 12, an upper groove portion 18D extending in the front-rear direction along the upper wall 13, and a front groove portion 18E extending in the up-down direction along the front wall 15.

The lower groove portion 18A is recessed from the upper surface of the lower wall 12, extends in the front-rear direction, and penetrates the lower wall 12. The lower groove portion 18A has a front lower groove portion 18B formed in an area in front of the front wall 15 in the front-rear direction, that is, the area of the projection 12A, and a rear lower groove portion 18C formed in an area in rear of the front lower groove portion 18B.

As shown in FIG. 4A, the front lower groove portion 18B is formed wide over the entire area. Moreover, a front end portion 18B-1 of the front lower groove portion 18B penetrates the projection 12A in the up-down direction. The rear lower groove portion 18C is, in the area of a front end portion of the rear lower groove portion 18C, continuous to the front lower groove portion 18B with a groove width increasing as extending forward, and is formed narrow in a great portion of an area other than the front end portion.

The upper groove portion 18D is recessed from the lower surface of the upper wall 13, extends in the front-rear direction, and penetrates the upper wall 13. The front groove portion 18E extends in the up-down direction, causes the lower groove portion 18A and the upper groove portion 18D to communicate with each other, and penetrates the front wall 15 in the front-rear direction. The upper groove portion 18D and the front groove portion 18E increase in a groove width as extending forward in the area of a front end portion thereof, and in an area other than the front end portion, are formed narrow with the same groove width dimension as that of the rear lower groove portion 18C.

As shown in FIG. 4A, a rear portion of the front groove portion 18E is formed with a second terminal holding portion 18F in which the second terminal 30 is to be press-fitted and held. The second terminal holding portion 18F extends in the groove width direction, and couples the opposing groove inner surfaces (two surfaces facing each other in the groove width direction) of the front groove portion 18E.

As shown in FIG. 5A, the lock metal fitting housing groove portion 19 is formed in a slit shape extending in the front-rear direction with the terminal arrangement direction as a groove width direction. The lock metal fitting housing groove portion 19 is formed so as to penetrate the housing 10 in the front-rear direction. The lock metal fitting housing groove portion 19 has a plurality of portions different from each other in a groove width dimension. Specifically, the lock metal fitting housing groove portion 19 has a narrow portion with a groove width dimension slightly wider than the plate thickness dimension of the lock metal fitting 40, and a wide portion with a greater groove width dimension than that of the narrow portion.

The lock metal fitting housing groove portion 19 has a lower groove portion 19A extending in the front-rear direction along the lower wall 12, an upper groove portion 19D extending in the front-rear direction along the upper wall 13, and a front groove portion 19E extending in the up-down direction along the front wall 15.

The lower groove portion 19A is recessed from the upper surface of the lower wall 12, extends in the front-rear direction, and penetrates the lower wall 12. The lower groove portion 19A has a front lower groove portion 19B formed in an area in front of the front wall 15 in the front-rear direction, that is, the area of the projection 12A, and a rear lower groove portion 19C formed in an area in rear of the front lower groove portion 19B.

As shown in FIG. 5A, the front lower groove portion 19B is formed narrow in an area other than a front end portion 19B-1 of the front lower groove portion 19B in the front-rear direction, and is formed wide in the area of the front end portion 19B-1. The front end portion 19B-1 of the front lower groove portion 19B penetrates the projection 12A in the up-down direction. Moreover, a rear portion of the front end portion 19B-1 increases in a groove width as extending forward.

The upper groove portion 19D is recessed from the lower surface of the upper wall 13, extends in the front-rear direction, and penetrates the upper wall 13. Front and rear portions of the upper groove portion 19D penetrate the upper wall 13 in the up-down direction. The front groove portion 19E extends in the up-down direction, causes the lower groove portion 19A and the upper groove portion 19D to communicate with each other, and penetrates the front wall 15 in the front-rear direction. The upper groove portion 19D and the front groove portion 19E increase in a groove width as extending forward in the area of front end portions thereof, and in an area other than the front end portions, are formed narrow with the same groove width dimension as that of the rear lower groove portion 19C.

As shown in FIG. 5A, a rear portion of the front groove portion 19E is formed with a lock metal fitting holding portion 19F in which the lock metal fitting 40 is to be press-fitted and held. The lock metal fitting holding portion 19F extends in the groove width direction, and couples the opposing groove inner surfaces (two surfaces facing each other in the groove width direction) of the front groove portion 19E.

As shown in FIGS. 2 and 3B, the first terminal 20 is formed in such a manner that a metal plate member is punched in the plate thickness direction thereof. The first terminal 20 has a lower arm portion 21 extending in the front-rear direction, an upper arm portion 22 extending in the front-rear direction above the lower arm portion 21, and a coupling portion 23 extending in the up-down direction and coupling intermediate portions of the lower arm portion 21 and the upper arm portion 22. The upper arm portion 22 receives pressing force from a first shaft portion 53 of the movable member 50, thereby elastically displacing as in a lever with the coupling portion 23 as a pivot point (see FIG. 10A).

As shown in FIG. 3B, the lower arm portion 21 extends in the front-rear direction along the lower wall 12 of the housing 10, and is housed in the lower groove portion 17A. The lower arm portion 21 has an extending portion 21A located in front of the coupling portion 23, and a base arm portion 21B, a connection portion 21C, a restriction target portion 21D, and a first lower contact arm portion 21E located in rear of the coupling portion 23.

The extending portion 21A extends along the groove bottom surface (lower inner wall surface) of the front lower groove portion 17B, and is supported from below by the groove bottom surface. The extending portion 21A has a support portion 21A-1 formed in a front portion, and a holding target portion 21A-2 formed in a rear portion. The support portion 21A-1 is located in the area of the projection 12A in the front-rear direction. A lower end portion of the support portion 21A-1 is housed in the front lower groove portion 17B. The support portion 21A-1 supports the first shaft portion 53 of the movable member 50 from below. The holding target portion 21A-2 is located at a position overlapping with the first terminal holding portion 17K in the front-rear direction, is located immediately below the first terminal holding portion 17K in the up-down direction, and is housed in the front lower groove portion 17B. The holding target portion 21A-2 is held in such a manner that a press-fit protrusion 21A-3 protruding from the upper end of the holding target portion 21A-2 bites into the lower surface of the first terminal holding portion 17K.

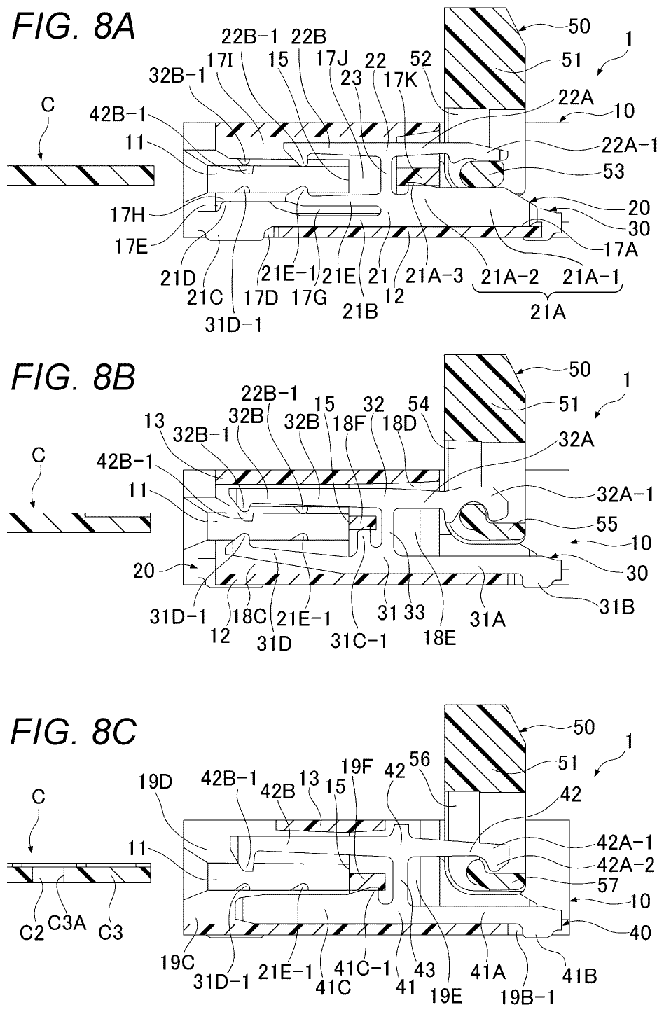

The base arm portion 21B extends rearward from the rear end of a lower portion of the holding target portion 21A-2 along the groove bottom surface (lower inner wall surface) of the rear lower groove portion 17C, and is supported from below by the groove bottom surface. The base arm portion 21B is formed smaller than the extending portion 21A in the up-down direction, that is, is formed thinner, and is housed in the third groove portion 17F. The connection portion 21C is coupled to the rear end of the base arm portion 21B, forms a rear end portion of the lower arm portion 21, and is housed in the first groove portion 17D. The connection portion 21C is formed greater than the base arm portion 21B in the up-down direction, that is, is formed thicker, and the lower end of the connection portion 21C is located slightly lower than the lower surface of the lower wall 12 (see FIG. 8A). The connection portion 21C is solderable with the lower end of the connection portion 21C being in surface contact with the circuit portion (pad) at the mounting surface of the circuit board (not shown).

The restriction target portion 21D is formed so as to extend upward from the upper end of the connection portion 21C, and is housed in the second groove portion 17E. The restriction target portion 21D is configured such that movement thereof in the terminal arrangement direction is restricted by the opposing inner wall surfaces of the second groove portion 17E as described later.

The first lower contact arm portion 21E extends rearward from the rear end of an upper portion of the holding target portion 21A-2 along the base arm portion 21B. That is, the first lower contact arm portion 21E is located with an area overlapping with the base arm portion 21B in the front-rear direction. The first lower contact arm portion 21E and the base arm portion 21B are provided with the areas overlapping with each other in the front-rear direction as described above, so that the first terminal 20 can be decreased in size in the front-rear direction by an amount corresponding to such an overlap.

As shown in FIG. 3B, the rear end of the first lower contact arm portion 21E is located at the intermediate position of the receiving portion 11 in the front-rear direction, specifically, in the vicinity of the restriction target portion 21D in front of the restriction target portion 21D. The first lower contact arm portion 21E is located above the base arm portion 21B with a gap with the base arm portion 21B, and is elastically displaceable in the up-down direction in the area of such a gap. The first lower contact arm portion 21E has, at the rear end thereof, the first lower contact portion 21E-1 protruding upward. The first lower contact portion 21E-1 protrudes upward to the receiving portion 11 such that the protruding end of the first lower contact portion 21E-1 is located in the receiving portion 11.

When the flat conductor C is inserted into the receiving portion 11, the first lower contact portion 21E-1 contacts the lower surface of the flat conductor C, and the first lower contact arm portion 21E presses the flat conductor C from below while elastically displacing downward (see FIG. 10A). Note that as a modification, in a case where the circuit portion is exposed on the lower surface of the front end portion of the flat conductor C, the first lower contact portion 21E-1 may contact such a circuit portion.

A portion of the first lower contact arm portion 21E other than the first lower contact portion 21E-1 is housed in the fourth groove portion 17G. The first lower contact arm portion 21E is configured such that movement thereof in the terminal arrangement direction is restricted by the opposing inner wall surfaces of the fourth groove portion 17G as described later. As shown in FIG. 3B, when the first lower contact arm portion 21E is in a free state, the upper end (protruding end) of the first lower contact portion 21E-1 is located in the receiving portion 11, and a lower portion (portion other than the upper end portion) thereof is housed in the fifth groove portion 17H (also see FIG. 8A).

As shown in FIG. 3B, the upper arm portion 22 extends in the front-rear direction along the groove bottom surface (upper inner wall surface) of the upper groove portion 17I, and is housed in the upper groove portion 17I. The upper arm portion 22 has a pressure receiving arm portion 22A located in front of the coupling portion 23, and a first upper contact arm portion 22B located in rear of the coupling portion 23.

A gap is formed between the upper arm portion 22 and the groove bottom surface of the upper groove portion 17I, and the upper arm portion 22 is elastically displaceable in the area of such a gap. Moreover, the upper arm portion 22 is configured such that movement thereof in the terminal arrangement direction is restricted by the opposing inner wall surfaces of the upper groove portion 17I.

A front portion of the pressure receiving arm portion 22A extends forward of the upper groove portion 17I of the housing 10, and is located in the movable member housing space 16. The front portion of the pressure receiving arm portion 22A is formed as a pressure receiving portion 22A-1 for receiving the pressing force from the first shaft portion 53 of the movable member 50 from below. The pressure receiving portion 22A-1 has a recess formed by recessing the lower edge thereof. When the movable member 50 is at the closed position, the pressure receiving portion 22A-1 is capable of housing part of the first shaft portion 53 in the recess (see FIG. 10A).

As shown in FIG. 3B, the rear end of the first upper contact arm portion 22B is at the intermediate position of the receiving portion 11 in the front-rear direction, specifically at the same position as that of the rear end of the first lower contact arm portion 21E in the front-rear direction. The first upper contact arm portion 22B has, at the rear end thereof, a first upper contact portion 22B-1 protruding downward.

When the flat conductor C is inserted into the receiving portion 11, the first upper contact portion 22B-1 contacts the upper surface of the flat conductor C, and the first upper contact arm portion 22B contacts, with contact pressure, the first circuit portion CIA at the upper surface of the flat conductor C from above while elastically displacing upward (see FIG. 10A).

The coupling portion 23 is housed in the front groove portion 17J, and in rear of the first terminal holding portion 17K, is adjacent to the first terminal holding portion 17K.

As shown in FIGS. 2 and 4B, the second terminal 30 is formed in such a manner that a metal plate member having the same plate thickness dimension as that of the first terminal 20 is punched in the plate thickness direction thereof. The second terminal 30 has a lower arm portion 31 extending in the front-rear direction, an upper arm portion 32 extending in the front-rear direction above the lower arm portion 31, and a coupling portion 33 extending in the up-down direction and coupling intermediate portions of the lower arm portion 31 and the upper arm portion 32. The upper arm portion 32 receives pressing force from a second shaft portion 55 of the movable member 50, thereby elastically displacing as in a lever with the coupling portion 33 as a pivot point (see FIG. 10B).

As shown in FIG. 4B, the lower arm portion 31 extends in the front-rear direction along the lower wall 12 of the housing 10, and is housed in the lower groove portion 18A. The lower arm portion 31 has a base arm portion 31A and a connection portion 31B located in front of the coupling portion 33, and a holding target portion 31C and a second lower contact arm portion 31D located in rear of the coupling portion 33.

The base arm portion 31A extends along the groove bottom surface (lower inner wall surface) of the front lower groove portion 18B, and is supported from below by the groove bottom surface. The base arm portion 31A has, at a front portion thereof, a support portion 31A-1 capable of supporting the second shaft portion 55 of the movable member 50 from below (see FIG. 4B). The support portion 31A-1 is located in the area of the projection 12A in the front-rear direction, and a lower end portion thereof is housed in the front lower groove portion 18B. When the movable member 50 is at the closed position, the support portion 31A-1 supports the second shaft portion 55 from below (see FIG. 10B).

The connection portion 31B is coupled to the front end of the base arm portion 31A, forms a front end portion of the lower arm portion 31, and is housed in the front end portion 18B-1 of the front lower groove portion 18B. The connection portion 31B is formed greater than the base arm portion 31A in the up-down direction, that is, is formed thicker, and the lower end of the connection portion 31B is located slightly lower than the lower surface of the lower wall 12 (see FIG. 8B). The connection portion 31B is solderable with the lower end of the connection portion 31B being in surface contact with the circuit portion (pad) at the mounting surface of the circuit board (not shown).

The holding target portion 31C is located at a position overlapping with the second terminal holding portion 18F in the front-rear direction, and is located immediately below the second terminal holding portion 18F in the up-down direction. The holding target portion 31C is held in such a manner that a press-fit protrusion 31C-1 protruding from the upper end of the holding target portion 31C bites into the lower surface of the second terminal holding portion 18F.

The second lower contact arm portion 31D extends rearward from the rear end of the holding target portion 31C. As shown in FIG. 4B, the second lower contact arm portion 31D is inclined upward as extending rearward. The second lower contact arm portion 31D is elastically displaceable in the up-down direction in the area of a gap formed between the second lower contact arm portion 31D and the groove bottom surface of the rear lower groove portion 18C. The second lower contact arm portion 31D has, at the rear end thereof, a second lower contact portion 31D-1 protruding upward.

When the flat conductor C is inserted into the receiving portion 11, the second lower contact portion 31D-1 contacts the lower surface of the flat conductor C, and the second lower contact arm portion 31D presses the flat conductor C from below while elastically displacing downward (see FIG. 10B). The second lower contact arm portion 31D is longer than the first lower contact arm portion 21E of the first terminal 20, and the rear end thereof extends to the vicinity of the rear end opening of the receiving portion 11. Thus, the second lower contact portion 31D-1 is located rearward of the first lower contact portion 21E-1. Note that as a modification, in a case where the circuit portion is exposed on the lower surface of the front end portion of the flat conductor C, the second lower contact portion 31D-1 may contact such a circuit portion.

As shown in FIG. 4B, the upper arm portion 32 extends in the front-rear direction along the groove bottom surface (upper inner wall surface) of the upper groove portion 18D, and is housed in the upper groove portion 18D. The upper arm portion 32 has a pressure receiving arm portion 32A located in front of the coupling portion 33, and a second upper contact arm portion 32B located in rear of the coupling portion 33.

A gap is formed between the upper arm portion 32 and the groove bottom surface of the upper groove portion 18D, and the upper arm portion 32 is elastically displaceable in the area of such a gap. Moreover, the upper arm portion 32 is configured such that movement thereof in the terminal arrangement direction is restricted by the opposing inner wall surfaces of the upper groove portion 18D.

A front portion of the pressure receiving arm portion 32A extends forward of the upper groove portion 18D of the housing 10, and is located in the movable member housing space 16. The front portion of the pressure receiving arm portion 32A is formed as a pressure receiving portion 32A-1 for receiving the pressing force from the second shaft portion 55 of the movable member 50 described later from below. The pressure receiving portion 32A-1 has a recess formed by recessing the lower edge thereof. When the movable member 50 is at the closed position, the pressure receiving portion 32A-1 is capable of housing part of the second shaft portion 55 in the recess (see FIG. 10B).

The second upper contact arm portion 32B has, at the rear end thereof, a second upper contact portion 32B-1 protruding downward. When the flat conductor C is inserted into the receiving portion 11, the second upper contact portion 32B-1 contacts the upper surface of the flat conductor C, and the second upper contact arm portion 32B contacts, with contact pressure, the second circuit portion C1B at the upper surface of the flat conductor C from above while elastically displacing upward (see FIG. 10B). The second upper contact arm portion 32B is longer than the first upper contact arm portion 22B of the first terminal 20, and extends to the vicinity of the rear end opening of the receiving portion 11. Thus, the second upper contact portion 32B-1 is located in rear of the first upper contact portion 22B-1 at the same position as that of the second lower contact portion 31D-1 in the front-rear direction.

The coupling portion 33 is housed in the front groove portion 18E, and in front of the second terminal holding portion 18F, is adjacent to the second terminal holding portion 18F.

As shown in FIGS. 2 and 5B, the lock metal fitting 40 is formed in such a manner that a metal plate member thicker than the first terminal 20 and the second terminal 30 is punched in the plate thickness direction thereof. The lock metal fitting 40 has a lower arm portion 41 extending in the front-rear direction, an upper arm portion 42 extending in the front-rear direction above the lower arm portion 41, and a coupling portion 43 extending in the up-down direction and coupling intermediate portions of the lower arm portion 41 and the upper arm portion 42. The upper arm portion 42 receives pressing force from a third shaft portion 57 of the movable member 50, thereby elastically displacing as in a lever with the coupling portion 43 as a pivot point (see FIG. 10C).

As shown in FIG. 5B, the lower arm portion 41 extends in the front-rear direction along the lower wall 12 of the housing 10, and is housed in the lower groove portion 19A. The lower arm portion 41 has a base arm portion 41A and a fixing portion 41B located in front of the coupling portion 43, and a holding target arm portion 41C located in rear of the coupling portion 43.

The base arm portion 41A extends along the groove bottom surface (lower inner wall surface) of the front lower groove portion 19B, and is supported from below by the groove bottom surface. The base arm portion 41A has, at a front portion thereof, a support portion 41A-1 capable of supporting the third shaft portion 57 of the movable member 50 described later from below (see FIG. 5B). The support portion 41A-1 is located in the area of the projection 12A in the front-rear direction, and a lower end portion thereof is housed in the front lower groove portion 19B. When the movable member 50 is at the closed position, the support portion 41A-1 supports the third shaft portion 57 from below (see FIG. 10C).

The fixing portion 41B is coupled to the front end of the base arm portion 41A, forms a front end portion of the lower arm portion 41, and is housed in the front end portion 19B-1 of the front lower groove portion 19B. The fixing portion 41B is formed greater than the base arm portion 41A in the up-down direction, that is, is formed thicker, and the lower end of the fixing portion 41B is located slightly lower than the lower surface of the lower wall 12 (see FIG. 8C). The fixing portion 41B is fixable by soldering with the lower end of the fixing portion 41B being in surface contact with a corresponding portion (pad) at the mounting surface of the circuit board (not shown).

The holding target arm portion 41C extends along the groove bottom surface (lower inner wall surface) of the rear lower groove portion 19C, and is supported from below by the groove bottom surface. A front portion of the holding target arm portion 41C is located at a position overlapping with the lock metal fitting holding portion 19F in the front-rear direction, and is located immediately below the lock metal fitting holding portion 19F in the up-down direction. The front portion of the holding target arm portion 41C is formed with a press-fit protrusion 41C-1 protruding from the upper end of the holding target arm portion 41C. The holding target arm portion 41C is held in such a manner that the press-fit protrusion 41C-1 bites into the lower surface of the lock metal fitting holding portion 19F.

As shown in FIG. 5B, the upper arm portion 42 extends in the front-rear direction along the groove bottom surface (upper inner wall surface) of the upper groove portion 19D, and is housed in the upper groove portion 19D. The upper arm portion 42 has a pressure receiving arm portion 42A located in front of the coupling portion 43, and a lock arm portion 42B located in rear of the coupling portion 43.

A gap is formed between the upper arm portion 42 and the groove bottom surface of the upper groove portion 19D, and the upper arm portion 42 is elastically displaceable in the area of such a gap. Moreover, the upper arm portion 42 is configured such that movement thereof in the terminal arrangement direction is restricted by the opposing inner wall surfaces of the upper groove portion 19D.

A front portion of the pressure receiving arm portion 42A extends forward of the upper groove portion 19D of the housing 10, and is located in the movable member housing space 16. The front portion of the pressure receiving arm portion 42A is formed as a pressure receiving portion 42A-1 for receiving the pressing force from the third shaft portion 57 of the movable member 50 from below. The front end of the pressure receiving portion 42A-1 is formed with a protrusion 42A-2 protruding downward, and the protrusion 42A-2 is lockable to the third shaft portion 57 of the movable member 50 from the front.

The lock arm portion 42B has, at the rear end thereof, the locking portion 42B-1 protruding downward, and the locking portion 42B-1 is lockable to the locking target portion C3A of the flat conductor C from the rear (see FIG. 10C). The rear end of the lock arm portion 42B extends to the vicinity of the rear end opening of the receiving portion 11. Thus, the locking portion 42B-1 is located in rear of the first upper contact portion 22B-1 of the first terminal 20 at the substantially same position as that of the second upper contact portion 32B-1 of the second terminal 30 in the front-rear direction.

As shown in FIG. 1, the movable member 50 is in a plate shape extending over the substantially entire width of the movable member housing space 16 in the terminal arrangement direction. The movable member 50 is movable (turnable) between the open position (see FIG. 1) at which the plate surface is parallel with the up-down direction and the closed position (see FIGS. 10A to 10C) at which the plate surface is parallel with the front-rear direction. At the open position, a lower portion of the movable member 50 is housed in the movable member housing space 16, and an upper portion of the movable member 50 extends upward of the movable member housing space 16. Such an upper portion forms an operation portion 51 for receiving operation for turning the movable member 50. The operation portion 51 extends outward of the movable member housing space 16 regardless of the turning position of the movable member 50.

As shown in FIGS. 1 and 2, the lower portion of the movable member 50 in the posture at the open position is formed with first slits 52, second slits 54, and third slits 56 penetrating the movable member 50 in the front-rear direction at positions each corresponding to the first terminals 20, the second terminals 30, and the lock metal fittings 40 in the terminal arrangement direction (also see FIGS. 3B, 4B, and 5B). That is, in the terminal arrangement area, the first slits 52 and the second slits 54 are alternately arranged and formed, and on each outer side of the terminal arrangement area, one third slit 56 is formed.

When the movable member 50 is at the open position, the first slit 52 houses the pressure receiving portion 22A-1 of the first terminal 20 as shown in FIG. 3B. Moreover, the first shaft portion 53 is provided in the first slit 52. The first shaft portion 53 is provided at a lower end position in the first slit 52, and couples the opposing inner wall surfaces of the first slit 52 in the terminal arrangement direction. As shown in FIG. 3B, the first shaft portion 53 has a section perpendicular to the terminal arrangement direction, which is in a substantially oval shape extending in the front-rear direction.

As shown in FIGS. 3B and 8A, the first shaft portion 53 is located between the support portion 21A-1 and the pressure receiving portion 22A-1 of the first terminal 20 in the up-down direction. At the open position, the first shaft portion 53 is supported by the upper end of the support portion 21A-1, and is located with a slight gap from the lower edge of the pressure receiving portion 22A-1. As described later, the first shaft portion 53 has a cam portion function of pushing up and displacing the pressure receiving portion 22A-1 upward while being supported by the support portion 21A-1 when the movable member 50 moves to the closed position (see FIG. 10A).

When the movable member 50 is at the open position, the second slit 54 houses the pressure receiving portion 32A-1 of the second terminal 30 as shown in FIG. 4B. Moreover, the second shaft portion 55 is provided in the second slit 54. The second shaft portion 55 is provided at a lower end position in the second slit 54, and couples the opposing inner wall surfaces of the second slit 54 in the terminal arrangement direction. As shown in FIG. 4B, the second shaft portion 55 has a section perpendicular to the terminal arrangement direction, which is in a shape extending in the front-rear direction, specifically a shape obtained by joining a substantially circular shape to an upper portion of a rear end portion of a substantially rectangular shape extending in the front-rear direction.

As shown in FIGS. 4B and 8B, the second shaft portion 55 is located between the support portion 31A-1 and the pressure receiving portion 32A-1 of the second terminal 30 in the up-down direction. At the open position, the second shaft portion 55 is located with a slight gap from the upper edge of the support portion 31A-1, and a rear end portion of the second shaft portion 55 contacts the lower edge of the recess of the pressure receiving portion 22A-1. As described later, the second shaft portion 55 has a cam portion function of pushing up and displacing the pressure receiving portion 32A-1 upward while being supported by the support portion 31A-1 when the movable member 50 moves to the closed position (see FIG. 10B).

When the movable member 50 is at the open position, the third slit 56 houses the pressure receiving portion 42A-1 of the lock metal fitting 40 as shown in FIG. 5B. Moreover, the third shaft portion 57 is provided in the third slit 56. The third shaft portion 57 is provided at a lower end position in the third slit 56, and couples the opposing inner wall surfaces of the third slit 56 in the terminal arrangement direction. As shown in FIG. 5B, the third shaft portion 57 has a section perpendicular to the terminal arrangement direction, which has a shape extending in the front-rear direction, specifically a shape obtained by joining a substantially circular shape to an upper portion of a rear end portion of a substantially rectangular shape extending in the front-rear direction.

As shown in FIGS. 5B and 8C, the third shaft portion 57 is located between the support portion 41A-1 and the pressure receiving portion 42A-1 of the lock metal fitting 40 in the up-down direction. At the open position, the third shaft portion 57 is located with a slight gap from the upper edge of the support portion 41A-1, and a rear end portion thereof contacts the lower edge of the pressure receiving portion 42A-1. As described later, the third shaft portion 57 has a cam portion function of pushing up and displacing the pressure receiving portion 42A-1 upward while being supported by the support portion 41A-1 when the movable member 50 moves to the closed position (see FIG. 10C).

The connector 1 is assembled in the following manner. First, the second terminals 30 are press-fitted in and attached to the second terminal housing groove portions 18 of the housing 10 from the front. Moreover, the lock metal fittings 40 are press-fitted in and attached to the lock metal fitting housing groove portions 19 of the housing 10 from the front. Note that either the attachment of the second terminals 30 or the attachment of the lock metal fittings 40 may be performed first, or both these attachments may be performed simultaneously.

Next, the lower portion of the movable member 50 is disposed in the movable member housing space 16 of the housing 10 from the front with the movable member 50 maintained in the posture at the open position (see FIG. 2). At this time, each second shaft portion 55 is disposed between the support portion 31A-1 and the pressure receiving portion 32A-1 of the second terminal 30, and each third shaft portion 57 is disposed between the support portion 41A-1 and the pressure receiving portion 42A-1 of the lock metal fitting 40.

Next, the first terminals 20 are press-fitted in and attached to the first terminal housing groove portions 17 of the housing 10 from the rear. As a result, each first shaft portion 53 of the movable member 50 is located between the support portion 21A-1 and the pressure receiving portion 22A-1 of the first terminal 20.

As a result of the attachment of the first terminals 20 to the housing 10, movement of each first shaft portion 53 in the up-down direction is restricted by the support portion 21A-1 and the pressure receiving portion 22A-1. Moreover, part of the rear end portion of each second shaft portion 55 is housed in the recess of the pressure receiving portion 32A-1 (see FIG. 5B), and part of the rear end portion of each third shaft portion 57 is disposed at a position at which such a portion is lockable to the protrusion 42A-2 of the pressure receiving portion 42A-1 from the rear (see FIG. 6B). As a result, unexpected detachment of the movable member 50 from the housing 10 can be reduced. In this manner, the movable member 50 is attached to the housing 10 in a movable state between the open position and the closed position, and the connector 1 is completed.

In the present embodiment, as shown in FIGS. 3A and 3B, in a state in which the first terminal 20 is press-fitted and held in the first terminal housing groove portion 17, the extending portion 21A of the lower arm portion 21 is housed in the narrow front lower groove portion 17B, the base arm portion 21B is housed in the wide third groove portion 17F, the connection portion 21C is housed in the wide first groove portion 17D, the restriction target portion 21D is housed in the narrow second groove portion 17E, the portion of the first lower contact arm portion 21E other than the first lower contact portion 21E-1 is housed in the narrow fourth groove portion 17G, and the lower portion (portion other than the upper end portion) of the first lower contact portion 21E-1 is housed in the wide fifth groove portion 17H. Moreover, the upper arm portion 22 is housed, except for the pressure receiving portion 22A-1, in the narrow upper groove portion 17I, and the coupling portion 23 is housed in the narrow front groove portion 17J.

Thus, the first terminal 20 is configured such that movement of the extending portion 21A, the restriction target portion 21D, the first lower contact arm portion 21E (other than the first lower contact portion 21E-1), the upper arm portion 22, and the coupling portion 23 in the terminal arrangement direction is restricted by the opposing groove inner surfaces of the narrow groove portions, that is, the front lower groove portion 17B, the second groove portion 17E, the fourth groove portion 17G, the upper groove portion 17I, and the front groove portion 17J. As a result, movement of the first terminal 20 in the terminal arrangement direction is restricted, and therefore, the first terminal 20 is easily maintained at a normal position.

Particularly, the restriction target portion 21D is provided immediately above the connection portion 21C, so that the restriction target portion 21D can be maintained at a normal position and therefore the connection portion 21C can also be easily maintained at a normal position. Thus, the connection portion 21C is easily and favorably connected to the corresponding circuit portion of the circuit board. Moreover, in the present embodiment, the fifth groove portion 17H in which the lower portion of the first lower contact portion 21E-1 is housed is wide, but the opposing groove inner surfaces of the narrow fourth groove portion 17G restrict movement of the first lower contact arm portion 21E, and therefore, the first lower contact portion 21E-1 is easily maintained at a normal position.

In the present embodiment, in a state in which the first terminal 20 is press-fitted and held in the first terminal housing groove portion 17, the base arm portion 21B, the connection portion 21C, and part (portion other than the upper end portion) of the first lower contact portion 21E-1 are located with the great gaps between the plate surfaces and the groove inner surfaces in the groove width direction in the wide groove portions, that is, the third groove portion 17F, the first groove portion 17D, and the fifth groove portion 17H. Thus, the gaps formed between the plate surface of the base arm portion 21B and the groove inner surface of the third groove portion 17F, between the plate surface of the connection portion 21C and the groove inner surface of the first groove portion 17D, and between the plate surface of the first lower contact portion 21E-1 and the groove inner surface of the fifth groove portion 17H are greater than the gaps formed between the plate surface of the holding target portion 21A-2 and the groove inner surface of the front lower groove portion 17B, between the plate surface of the restriction target portion 21D and the groove inner surface of the second groove portion 17E, between the plate surface of the first lower contact arm portion 21E and the groove inner surface of the fourth groove portion 17G, between the plate surface of the upper arm portion 22 and the groove inner surface of the upper groove portion 17I, and between the plate surface of the coupling portion 23 and the groove inner surface of the front groove portion 17J.

Particularly, the great gap is formed between the plate surface of the connection portion 21C and the groove inner surface of the first groove portion 17D, so that capillary action does not occur in such a gap when the connection portion 21C is soldered to the circuit portion of the circuit board and therefore solder wicking can be favorably reduced. Moreover, the third groove portion 17F communicating with the first groove portion 17D is also wide and the great gap is formed between the plate surface of the base arm portion 21B and the groove inner surface of the third groove portion 17F, so that the solder wicking can be more favorably reduced.

The second groove portion 17E housing the restriction target portion 21D immediately above the connection portion 21C is narrow, but if no solder wicking occurs below the second groove portion 17E, that is, in the first groove portion 17D located on the circuit board side, no solder wicking occurs in the second groove portion 17E.

In the present embodiment, the base arm portion 21B and the first lower contact arm portion 21E are provided with the areas overlapping with each other in the front-rear direction in the first terminal 20, and therefore, the connection portion 21C coupled to the rear end of the base arm portion 21B is located near the first lower contact portion 21E-1. However, the base arm portion 21B and the first lower contact arm portion 21E are formed as separate arm portions, and therefore, in the first terminal 20, a continuous path from the connection portion 21C to the first lower contact portion 21E-1 is a path along the base arm portion 21B, the holding target portion 21A-2, and the first lower contact arm portion 21E. Thus, the connection portion 21C and the first lower contact portion 21E-1 are greatly apart from each other on this path. Further, the great gap is formed between the base arm portion 21B and the groove inner surface of the third groove portion 17F, and therefore, no solder wicking occurs in the area of the base arm portion 21B. Thus, movement of molten solder from the connection portion 21C to the first lower contact portion 21E-1 can be more favorably reduced.

In the present embodiment, as shown in FIGS. 4A and 4B, in a state in which the second terminal 30 is press-fitted and held in the second terminal housing groove portion 18, a portion of the base arm portion 31A of the lower arm portion 31 other than the support portion 31A-1 is housed in the narrow portion of the front lower groove portion 18B, and the holding target portion 31C and the second lower contact arm portion 31D are housed in the narrow rear lower groove portion 18C. Moreover, the upper arm portion 32 is housed, except for the pressure receiving portion 32A-1, in the narrow upper groove portion 18D, and the coupling portion 33 is housed in the narrow front groove portion 18E.

Thus, the second terminal 30 is configured such that movement of part (portion other than the support portion 31A-1) of the base arm portion 31A, the holding target portion 31C, the second lower contact arm portion 31D, the upper arm portion 32, and the coupling portion 33 in the terminal arrangement direction is restricted by the opposing groove inner surfaces of the narrow groove portions, that is, the narrow portion of the front lower groove portion 18B, the rear lower groove portion 18C, the upper groove portion 18D, and the front groove portion 18E. As a result, movement of the second terminal 30 in the terminal arrangement direction is restricted, and therefore, the second terminal 30 is easily maintained at a normal position.

In the present embodiment, in a state in which the second terminal 30 is press-fitted and held in the second terminal housing groove portion 18, the support portion 31A-1 and the connection portion 31B are located with the great gaps between the plate surfaces and the groove inner surfaces in the groove width direction in the wide groove portion, that is, the wide portion of the front lower groove portion 18B.

Particularly, as shown in FIGS. 6A and 6B, the great gap is formed between the plate surface of the connection portion 31B and the groove inner surface of the front end portion 18B-1 of the front lower groove portion 18B, so that capillary action does not occur in such a gap when the connection portion 31B is soldered to the circuit portion of the circuit board and therefore the solder wicking can be favorably reduced. Moreover, a portion of the front lower groove portion 18B communicating with the front end portion 18B-1 is wide and the great gap is formed between the plate surface of the support portion 31A-1 and the groove inner surface of such a portion, so that the solder wicking can be more favorably reduced. Note that FIGS. 6A and 6B do not show the movable member 50.

In the present embodiment, as shown in FIGS. 5A and 5B, in a state in which the lock metal fitting 40 is press-fitted and held in the lock metal fitting housing groove portion 19, the rear end portion (portion other than the support portion 41A-1) of the base arm portion 41A of the lower arm portion 41 is housed in the narrow portion of the front lower groove portion 19B, and the holding target arm portion 41C is housed in the narrow rear lower groove portion 19C. Moreover, the upper arm portion 42 is housed, except for the pressure receiving portion 42A-1, in the narrow upper groove portion 19D, and the coupling portion 43 is housed in the narrow front groove portion 19E.

Thus, the lock metal fitting 40 is configured such that movement of the rear end portion of the base arm portion 41A, the holding target arm portion 41C, and the upper arm portion 42 in the terminal arrangement direction is restricted by the opposing groove inner surfaces of the narrow groove portions, that is, the rear lower groove portion 19C, the upper groove portion 19D, and the front groove portion 19E which are the narrow portions of the front lower groove portion 19B. As a result, movement of the lock metal fitting 40 in the terminal arrangement direction is restricted, and therefore, the lock metal fitting 40 is easily maintained at a normal position.

In the present embodiment, in a state in which the lock metal fitting 40 is press-fitted and held in the lock metal fitting housing groove portion 19, the support portion 41A-1 and the fixing portion 41B are located with the great gaps between the plate surfaces and the groove inner surfaces in the groove width direction in the wide groove portion, that is, the wide portion of the front lower groove portion 19B.

Particularly, as shown in FIGS. 6A and 6B, the great gap is formed between the plate surface of the fixing portion 41B and the groove inner surface of the front end portion 19B-1 of the front lower groove portion 19B, so that the capillary action does not occur in such a gap when the fixing portion 41B is soldered to the corresponding portion of the circuit board and therefore the solder wicking can be favorably reduced. Moreover, a portion of the front lower groove portion 19B communicating with the front end portion 19B-1 is wide and the great gap is formed between the plate surface of the support portion 41A-1 and the groove inner surface of such a portion, so that the solder wicking can be more favorably reduced.

In the present embodiment, after completion of the connector 1, an inspection is performed for identifying the positions of the protruding ends of the first lower contact portion 21E-1 and the first upper contact portion 22B-1 of the first terminal 20 in the up-down direction and the positions of the protruding ends of the second lower contact portion 31D-1 and the second upper contact portion 32B-1 of the second terminal 30 in the up-down direction. Here, the “protruding ends” indicate the upper end of the first lower contact portion 21E-1, the lower end of the second upper contact portion 32B-1, the upper end of the second lower contact portion 31D-1, and the lower end of the second upper contact portion 32B-1. In the following description, the first lower contact portion 21E-1 and the first upper contact portion 22B-1 may be referred to as a “first contact portion(s) 21E-1, 22B-1”, and the second lower contact portion 31D-1 and the second upper contact portion 32B-1 may be referred to as a “second contact portion(s) 31D-1, 32B-1”.

An inspection device (not shown) used for the inspection has an emitter, an imager, and a position identifier. In the inspection, the emitter emits light to the receiving portion 11 from the rear, and a light reflection state is imaged from the rear by the imager. Further, the position identifier identifies the position of the protruding end of each contact portion based on the captured image. Specifically, for example, based on a difference in light and dark (contrast) between light reflected on the first contact portions 21E-1, 22B-1 and the second contact portions 31D-1, 32B-1 protruding to the receiving portion 11 and light reflected on a portion around the first contact portions 21E-1, 22B-1 and the second contact portions 31D-1, 32B-1 when viewed from the rear, the position of the protruding end of each of the first contact portions 21E-1, 22B-1 and the second contact portions 31D-1, 32B-1 is identified. In the present embodiment, the position of the protruding end is identified by measurement of a distance from a reference position, which is the upper end position of the rear end surface of the lower wall 12, in the up-down direction.

In the present embodiment, the first lower contact portion 21E-1 of the first terminal 20 is provided at the intermediate position of the receiving portion 11 in the front-rear direction, and is located forward of the rear end surface of the lower wall 12. If the fifth groove portion 17H housing the lower portion of the first lower contact portion 21E-1 is narrow and, for example, the groove width dimension of the fifth groove portion 17H is the groove width of the fourth groove portion 17G or less, the position of the upper end of the first lower contact portion 21E-1 is identified based on the contrast between the light reflected on the first lower contact portion 21E-1 and the light reflected on the rear end surface of the lower wall 12 formed with the fifth groove portion 17H in the housing 10. However, as described above, the first lower contact portion 21E-1 is located forward of the rear end surface of the lower wall 12. In other words, the rear end surface of the lower wall 12 is shifted rearward from the first lower contact portion 21E-1. That is, since the rear end surface of the lower wall 12 is greatly shifted from the first lower contact portion 21E-1 in the front-rear direction, it is difficult to bring both the rear end surface of the lower wall 12 and the first lower contact portion 21E-1 into focus at the time of imaging from the rear and to capture a clear image.

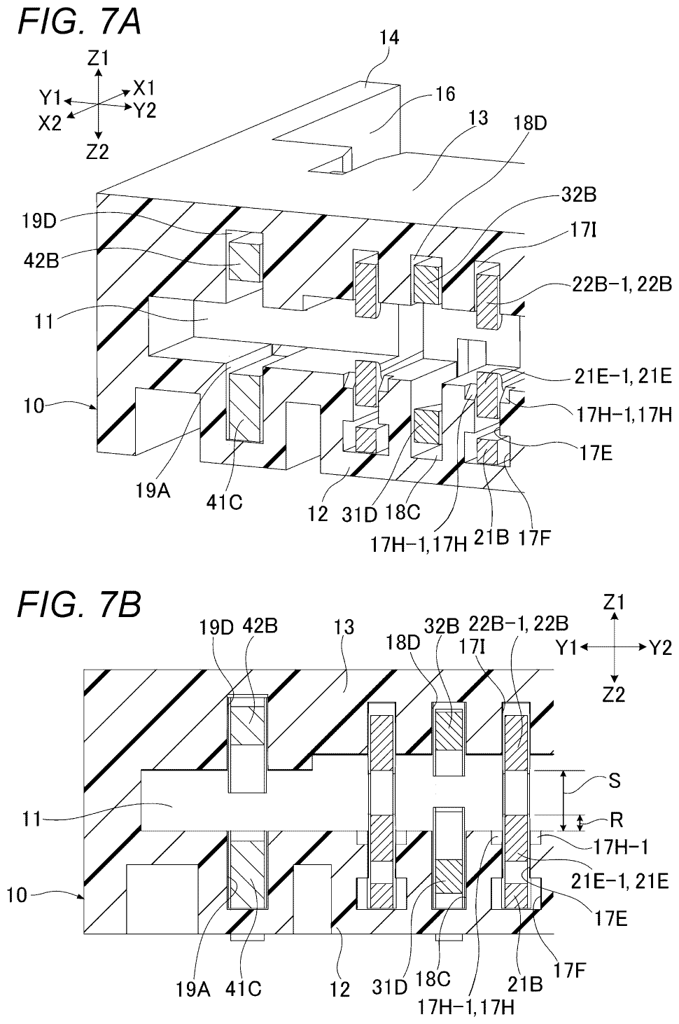

In the present embodiment, the great gap is formed between the lower portion of the first lower contact portion 21E-1 and the groove inner surface of the fifth groove portion 17H, and the fifth groove portion 17H is closed from the front with the front inner surface 17H-1. That is, when viewed from the rear, the front inner surface 17H-1 is present around the first lower contact portion 21E-1 as shown in FIGS. 7A and 7B. Thus, the position of the upper end (protruding end) of the first lower contact portion 21E-1 can be identified based on the contrast between the light reflected on the first lower contact portion 21E-1 and the light reflected on the front inner surface 17H-1. Specifically, the position of such an upper end is identified in such a manner that with the upper end position of the front inner surface 17H-1 at the same position as the upper end position of the rear end surface of the lower wall 12 as a reference position, a distance (distance R shown in FIG. 7B) from the reference position to the upper end of the first lower contact portion 21E-1 in the up-down direction is measured. Note that FIGS. 7A and 7B do not show the movable member 50.

In the present embodiment, as shown in FIG. 7A, the front inner surface 17H-1 is located in the area of the first lower contact portion 21E-1 in the front-rear direction. In other words, the front inner surface 17H-1 is close to the first lower contact portion 21E-1 in the front-rear direction. Thus, at the time of imaging from the rear, both the front inner surface 17H-1 and the first lower contact portion 21E-1 are easily brought into focus and the clear image is easily captured, and therefore, the upper end position of the first lower contact portion 21E-1 can be easily identified.

The position of the lower end (protruding end) of the first upper contact portion 22B-1 is also identified in such a manner that with the position of the upper end of the front inner surface 17H-1 of the fifth groove portion 17H as a reference position, a distance (distance S shown in FIG. 7B) from the reference position to the lower end of the first upper contact portion 22B-1 in the up-down direction is measured. The first upper contact portion 22B-1 is at the same position as that of the first lower contact portion 21E-1 in the front-rear direction. Thus, the front inner surface 17H-1 of the fifth groove portion 17H is close to the first upper contact portion 22B-1 in the front-rear direction. As a result, at the time of imaging from the rear, both the front inner surface 17H-1 and the first upper contact portion 22B-1 are easily brought into focus and the clear image is easily captured, and therefore, the position of the lower end of the first upper contact portion 22B-1 can be easily identified.

On the other hand, the positions of the protruding ends of the second contact portions 31D-1, 32B-1 of the second terminal 30 are identified in such a manner that with the upper end position of the rear end surface of the lower wall 12 as a reference position, each protruding end from the reference position is measured. In the present embodiment, the second contact portion 31D-1, 32B-1 is located close to the rear end opening of the receiving portion 11, in other words, near the rear end surface of the lower wall 12, in the front-rear direction. Thus, at the time of imaging from the rear, both the rear end surface of the lower wall 12 and the second contact portion 31D-1, 32B-1 are easily brought into focus and the clear image is easily captured, and therefore, the position of the protruding end of the second contact portion 31D-1, 32B-1 can be easily identified.

Next, an operation of inserting the flat conductor C into the connector 1 and extracting the flat conductor C from the connector 1 will be described. First, the connection portions 21C of the first terminals 20 and the connection portions 31B of the second terminals 30 of the connector 1 are each soldered to the corresponding circuit portions of the circuit board (not shown), and the fixing portions 41B of the lock metal fittings 40 are soldered to the corresponding portions of the circuit board. By such soldering of the connection portions 21C, the connection portions 31B, and the fixing portions 41B, the connector 1 is attached to the circuit board.

When the flat conductor C is connected to the connector 1, the flat conductor C is located in rear of the connector 1, of which the movable member 50 is moved to the open position, so as to extend in the front-rear direction (X-axis direction), as shown in FIGS. 1 and 8A to 8C.

Next, the flat conductor C is inserted forward (X1 direction) into the receiving portion 11 of the connector 1. In the course of inserting the flat conductor C into the receiving portion 11, the front end of the flat conductor C first contacts the second lower contact portions 31D-1 and the second upper contact portions 32B-1 of the second terminals 30, and pushes out the second lower contact arm portions 31D and the second upper contact arm portions 32B. That is, each second lower contact arm portion 31D elastically displaces downward, and each second upper contact arm portion 32B elastically displaces upward. Substantially at the same time, the front end of the flat conductor C contacts the locking portions 42B-1 of the lock metal fittings 40, and elastically displaces the lock arm portions 42B upward.

When the flat conductor C is further inserted forward, the front end of the flat conductor C contacts the first lower contact portions 21E-1 and the first upper contact portions 22B-1 of the first terminals 20, and pushes out the first lower contact arm portions 21E and the first upper contact arm portions 22B. That is, each first lower contact arm portion 21E elastically displaces downward, and each first upper contact arm portion 22B elastically displaces upward. When the flat conductor C is further inserted forward and the front end of the flat conductor C contacts the front wall 15 from the rear, the insertion of the flat conductor C is completed (see FIGS. 9A to 9C).

Even after completion of the insertion of the flat conductor C, the first lower contact arm portions 21E, the first upper contact arm portions 22B, the second lower contact arm portions 31D, and the second upper contact arm portions 32B remain elastically displaced, and the flat conductor C is sandwiched by the first contact portions 21E-1, 22B-1 and the second contact portions 31D-1, 32B-1. As a result, each first upper contact portion 22B-1 contacts, with the contact pressure, the first circuit portion C1A of the flat conductor C, and each second upper contact portion 32B-1 contacts, with the contact pressure, the second circuit portion C1B of the flat conductor C.

After each lock arm portion 42B has elastically displaced upward in the course of inserting the flat conductor C, when each ear portion C3 of the flat conductor C passes by the position of the locking portion 42B-1, the lock arm portion 42B of each lock metal fitting 40 returns to a free state, and each locking portion 42B-1 enters the cutout C2 of the flat conductor C from above. As a result, as shown in FIG. 9C, after completion of the insertion of the flat conductor C, each locking portion 42B-1 is located lockable to the locking target portion C3A of the flat conductor C from the rear. Note that it is not essential for the lock arm portion 42B to fully return to the free state. For example, with a slight extra elastic displacement amount of the lock arm portion 42B, the locking portion 42B-1 may enter the cutout C2 of the flat conductor C.

Next, the operation portion 51 of the movable member 50 is operated with a finger to move (turn) the movable member 50 from the open position to the closed position. When the movable member 50 moves to the closed position, the first shaft portions 53, the second shaft portions 55, and the third shaft portions 57 are brought into postures extending with the up-down direction as a longitudinal direction, as shown in FIGS. 10A to 10C. At this time, in a state of being supported from below by the support portions 21A-1 and the support portions 31A-1, the first shaft portions 53 and the second shaft portions 55 each located corresponding to the first terminals 20 and the second terminals 30 press the pressure receiving portions 22A-1 and the pressure receiving portions 32A-1 from below, and displace the pressure receiving arm portions 22A and the pressure receiving arm portions 32A upward. As a result, as shown in FIGS. 10A and 10B, each upper arm portion 22 and each upper arm portion 32 displace as in a lever, and each first upper contact arm portion 22B and each second upper contact arm portion 32B displace downward. Then, each first upper contact portion 22B-1 and each second upper contact portion 32B-1 contact, with increased contact pressure, the first circuit portion CIA and the second circuit portion C1B of the flat conductor C, and the electrical conduction state is maintained.

When the movable member 50 moves to the closed position, the third shaft portions 57 located corresponding to the lock metal fittings 40 press the pressure receiving portions 42A-1 from below, and displace the pressure receiving arm portions 42A upward, as shown in FIG. 10C. As a result, the upper arm portions 42 displace as in a lever, and accordingly, the lock arm portions 42B displace downward and the locking portions 42B-1 enter deeper in the cutouts C2 of the flat conductor C. Thus, a state of the locking portion 42B-1 being lockable to the locking target portion C3A from the rear is maintained, and the extraction of the flat conductor C to the rear is favorably reduced. The movable member 50 moves to the closed position as described above, and in this manner, an operation of connecting the flat conductor C to the connector 1 is completed.

In the above-described embodiment, the case where the size of the gap between the first terminal 20 and the groove inner surface of the first terminal housing groove portion 17 depends on the groove width of the first terminal housing groove portion 17 has been described. That is, in the above-described embodiment, the example where the size of the gap between the first terminal 20 and the groove inner surface of the first terminal housing groove portion 17 is changed by changing the groove width of the first terminal housing groove portion 17 has been described.

Specifically, for the connection portion 21C and the first groove portion 17D, the great gap is formed between the connection portion 21C and the first groove portion 17D by forming the connection portion 21C of the first terminal 20 with the uniform plate thickness dimension and widening the first groove portion 17D of the housing 10 housing the connection portion 21C, and as a result, the capillary action and therefore the solder wicking at the time of soldering of the connection portion 21C are reduced.

However, the form for forming the great gap between the connection portion 21C and the groove inner surface of the first groove portion 17D is not limited thereto, and various modifications can be made. For example, as a modification, the size of the gap between the first terminal 20 and the groove inner surface of the first terminal housing groove portion 17 may depend on the plate thickness of the first terminal 20.

For example, specifically, the great gap may be formed between the connection portion 21C and the groove inner surface of the first groove portion 17D by narrowing the first groove portion 17D and forming the connection portion 21C of the first terminal 20 thinner.

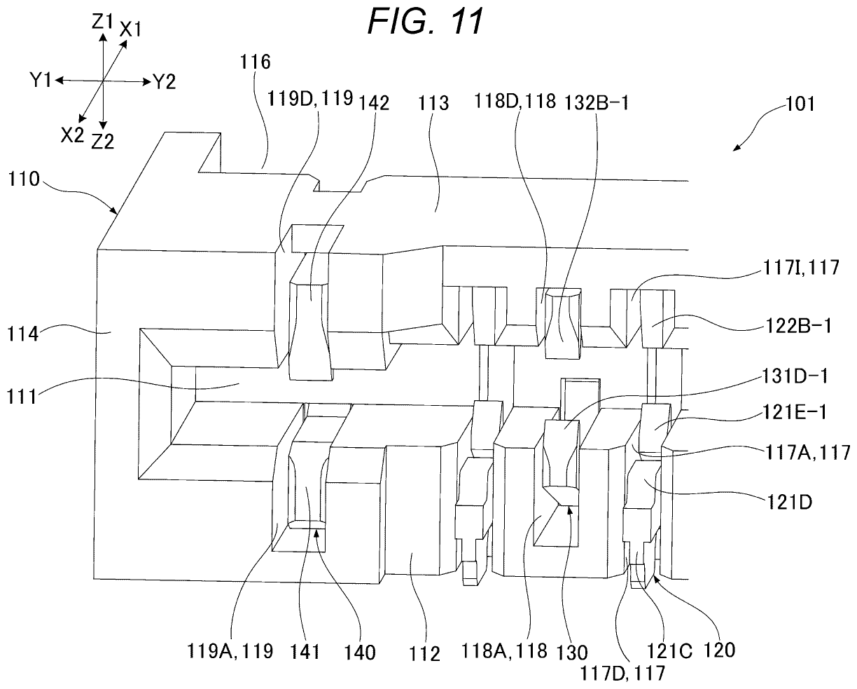

FIG. 11 is a perspective view showing part of a connector 101 according to this modification from the rear side. FIG. 11 does not show a movable member. Moreover, in FIG. 11, elements corresponding to those of the above-described embodiment are denoted with reference numerals obtained by further adding “100” to the reference numerals of the above-described embodiment. Hereinafter, configuration differences of this modification from the above-described embodiment will be mainly described, and the description of elements common to those of the above-described embodiment will be omitted.

In this modification, as shown in FIG. 11, the first groove portion 117D of the housing 110 housing the connection portion 121C of the first terminal 120 is formed as a narrow groove portion. Moreover, the connection portion 121C is formed such that a lower portion thereof has a smaller plate thickness dimension than that of an upper portion, that is, is formed thinner. Thus, a great gap is formed in the groove width direction between the connection portion 121C and the groove inner surface of the first groove portion 117D. As a result, when the connection portion 121C is soldered to the corresponding circuit portion of the circuit board, the solder wicking is favorably reduced without occurrence of the capillary action in such a gap.

In this modification, the configuration of the modification for reducing the solder wicking in the connection portion 121C of the first terminal 120 has been described, but in addition to this configuration, a similar configuration may be employed for the connection portion 131B of the second terminal 130 and the fixing portion 141B of the lock metal fitting 140. Specifically, the great gap is formed between the connection portion 131B and the groove inner surface of the front end portion of the front lower groove portion of the second terminal housing groove portion 118 by narrowing the front end portion of the front lower groove portion and forming the lower portion of the connection portion 131B of the second terminal 130 thinner. Moreover, the great gap is formed between the fixing portion 141B and the groove inner surface of the front end portion of the front lower groove portion of the lock metal fitting housing groove portion 119 by narrowing the front end portion of the front lower groove portion and forming the lower portion of the fixing portion 141B thinner. It is not essential to form only the lower portions of the connection portion 121C, the connection portion 131B, and the fixing portion 141B thinner, and for example, the entireties of the connection portion 121C, the connection portion 131B, and the fixing portion 141B may be formed thinner.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. An electrical connector for a flat conductor which is mounted on a circuit board and to which a flat conductor is connected, comprising:
a plurality of terminals formed of metal plates; and
a housing holding the plurality of terminals,
wherein the plurality of terminals is arranged such that plate surfaces of the plurality of terminals face each other with a left-right direction perpendicular to a front-rear direction and an up-down direction of the electrical connector for the flat conductor as a terminal arrangement direction,
the housing has a receiving portion and a plurality of housing groove portions,
the receiving portion is opened rearward to receive the flat conductor inserted forward from a rear of the housing,
each of the plurality of housing groove portions extends in the front-rear direction with the terminal arrangement direction as a groove width direction, and is configured to house a corresponding one of the plurality of terminals,
each of the plurality of terminals has a connection portion and a restriction target portion located lower than the receiving portion, the connection portion is connectable to the circuit board, and the restriction target portion extends upward of the connection portion,
each of the plurality of housing groove portions has a first groove portion for housing the connection portion, and a second groove portion for housing the restriction target portion, and
a gap between the connection portion and a groove inner surface of the first groove portion in the terminal arrangement direction is greater than a gap between the restriction target portion and a groove inner surface of the second groove portion in the terminal arrangement direction.

2. The electrical connector for the flat conductor according to claim 1, wherein
each of the plurality of terminals further has a holding target portion to be held by the housing, and a contact arm portion and a base arm portion located lower than the receiving portion and extending rearward of the holding target portion,
the contact arm portion has a contact portion contactable with the flat conductor,
the base arm portion is located lower than the contact arm portion, and has an area overlapping with the contact arm portion in the front-rear direction,
the connection portion is provided at a rear end of the base arm portion,
each housing groove portion has a third groove portion communicating with the first groove portion and provided for housing the base arm portion, and
a gap between the base arm portion and a groove inner surface of the third groove portion in the terminal arrangement direction is greater than the gap between the restriction target portion and the groove inner surface of the second groove portion in the terminal arrangement direction.

3. The electrical connector for the flat conductor according to claim 2, wherein
each of the plurality of housing groove portions has a fourth groove portion for housing part of the contact arm portion, and
a gap between the part of the contact arm portion and a groove inner surface of the fourth groove portion in the terminal arrangement direction is smaller than the gap between the base arm portion and the groove inner surface of the third groove portion in the terminal arrangement direction.

4. The electrical connector for the flat conductor according to claim 3, wherein
a groove width of the second groove portion and a groove width of the fourth groove portion are equal to each other, and the second groove portion and the fourth groove portion communicate with each other to form one groove portion.

5. The electrical connector for the flat conductor according to claim 3, wherein
the contact portion protrudes upward to the receiving portion such that a protruding end of the contact portion is located in the receiving portion,
each of the plurality of housing groove portions has a fifth groove portion for housing part of the contact portion, and the fifth groove portion has a front inner surface located in an area of the contact portion in the front-rear direction and extends to the front inner surface from a rear end of the housing in the front-rear direction, and
a gap between the part of contact portion and a groove inner surface of the fifth groove portion in the terminal arrangement direction is greater than the gap between the part of the contact arm portion and the groove inner surface of the fourth groove portion in the terminal arrangement direction.

6. The electrical connector for the flat conductor according to claim 1, wherein
a groove width of the first groove portion is greater than a groove width of the second groove portion.

7. The electrical connector for the flat conductor according to claim 2, wherein
a groove width of the third groove portion is greater than a groove width of the second groove portion.

8. The electrical connector for the flat conductor according to claim 3, wherein
a groove width of the fourth groove portion is greater than a groove width of the third groove portion.

9. The electrical connector for the flat conductor according to claim 5, wherein
a groove width of the fifth groove portion is greater than a groove width of the fourth groove portion.
